(19) United States
(12) Patent Application Publication
(10) Pub. No.: US 2014/0023929 A1
(43) Pub. Date: Jan. 23, 2014

(54) Silicon-Containing Carbonaceous Composite Material

(71) Applicants: Hiroshi Fukui, Kawasaki-shi (JP); Yukinari Harimoto, Hadano-shi (JP); Masayasu Akasaka, Chiba-shi (JP); Son Thanh Phan, Chiba-shi (JP); Takakazu Hino, Yokohama-shi (JP); Katsuya Eguchi, Minami Ashigara-shi (JP); Yoshito Ushio, Chiba-shi (JP)

(72) Inventors: Hiroshi Fukui, Kawasaki-shi (JP); Yukinari Harimoto, Hadano-shi (JP); Masayasu Akasaka, Chiba-shi (JP); Son Thanh Phan, Chiba-shi (JP); Takakazu Hino, Yokohama-shi (JP); Katsuya Eguchi, Minami Ashigara-shi (JP); Yoshito Ushio, Chiba-shi (JP)

(21) Appl. No.: 13/982,673

(22) PCT Filed: Jan. 27, 2012
(86) PCT No.: PCT/JP2012/052444

§ 371 Date: Sep. 24, 2013

(30) Foreign Application Priority Data
Jan. 31, 2011 (JP) 2011-018236
Feb. 17, 2011 (JP) 2011-032463

(51) Int. Cl. H01M 4/36; H01M 4/134; H01M 4/133; H01M 4/38; H01M 4/48

(52) U.S. Cl. CPC H01M 4/364; H01M 4/386; H01M 4/48; H01M 4/133; H01M 4/134
USPC 429/231.8; 252/182.1

(57) ABSTRACT

Using a silicon-containing carbon-based composite material represented by the compositional formula: SiOₓC_{y}H_{z}. In this formula, “x” is from 0.8 to 1.7, “y” is from 1.4 to 7.5, and “z” is from 0.3 to 1.3. The composite material is preferably obtained by: obtaining a cured product by crosslinking (A) a crosslinkable group-containing organic compound, and (B) a silicon-containing compound capable of crosslinking the crosslinkable group-containing organic compound, and heat treating the obtained cured product. The composite material of the present invention has high reversible capacity and stable charge and discharge cycle characteristics, and has high initial charge and discharge efficiency. Therefore, the composite material of the present invention is suitable for an electrode of an electricity storage device, particularly of a lithium or lithium-ion secondary battery.

### TECHNICAL FIELD

The present invention relates to a silicon-containing carbon-based composite material, an electrode active material constituted by the composite material, an electrode comprising the active material, and an electricity storage device comprising the electrode.

### BACKGROUND ART

Electricity storage devices and particularly lithium or lithium-ion secondary batteries are being investigated as a type of high energy density secondary battery. It is commonly known that a negative electrode material for a lithium-ion secondary battery having high charging and discharging capacity that significantly exceeds the theoretical capacity of graphite can be obtained by baking an arbitrary carbon source in an inert gas or a vacuum at a temperature near 1,000° C. J. Electrochem. Soc., 142, 2581 (1995) describes that reversible capacity exceeding 800 mAh/g can be obtained by baking an arbitrary carbon source in an argon atmosphere, and then using the obtained carbon material as a negative electrode material. However, carbon materials that are obtained through baking in this temperature range have low initial charging and discharging efficiency and insufficient charge and discharge cycle characteristics.

On the other hand, in many cases, a silicon-containing carbon material obtained by pyrolyzing a silicon polymer is used as the negative electrode material for a lithium-ion secondary battery. For example, Japanese Unexamined Patent Application Publication No. H10-97853 and Solid State Ionics, 122, 71 (1999) describe fabricating a material usable in the manufacturing of a battery having a large capacity by using a polysilane and a coal tar pitch as precursors. Additionally, Japanese Unexamined Patent Application Publication No. H10-74506, Japanese Unexamined Patent Application Publication No. H10-275617, Japanese Unexamined Patent Application Publication No. 2004-273377, and J. Electrochem. Soc., 144, 2410 (1997) describe obtaining a battery having a large capacity by pyrolyzing a siloxane polymer and, thereafter, introducing lithium in order to form an electrode for a lithium or lithium-ion secondary battery. However, while reversible capacity of such lithium-ion secondary batteries that comprise an electrode including a silicon-containing carbon material is high, practical performance is insufficient with regards to low initial charging and discharging efficiency, charge and discharge cycle characteristics, and the like.

Japanese Unexamined Patent Application Publication No. 2006-062949 describes a silicon-containing carbon material obtained by curing and baking a siloxane polymer comprising graphite or a similar graphene-based material. However, the reversible capacity of lithium or lithium-ion secondary batteries comprising electrodes including a silicon-containing carbon material such as that described above is limited due to the crystalline structure of the graphite or the like.

### PRIOR ART DOCUMENTS

### Patent Documents

Patent Document 1: Japanese Unexamined Patent Application Publication No. H10-97853
Patent Document 2: Japanese Unexamined Patent Application Publication No. H10-74506
Patent Document 3: Japanese Unexamined Patent Application Publication No. H10-275617
Patent Document 4: Japanese Unexamined Patent Application Publication No. 2004-273377
Patent Document 5: Japanese Unexamined Patent Application Publication No. 2006-062949

### Non-Patent Documents

Non-Patent Document 1: J. Electrochem. Soc., 142, 2581 (1995)
Non-Patent Document 2: Solid State Ionics, 122, 71 (1999)
Non-Patent Document 3: J. Electrochem. Soc., 144, 2410 (1997)

### SUMMARY OF INVENTION

An object of the present invention is to provide a composite material suitable for use as an electrode of an electricity storage device, particularly for a lithium or lithium-ion secondary battery, an electrode active material constituted by the composite material, an electrode containing the active material, and an electricity storage device including the electrode.

The object of the present invention is achieved by a silicon-containing carbon-based composite material represented by the compositional formula: SiOₓC_{y}H_{z}

(wherein “x” is from 0.8 to 1.5, “y” is from 1.4 to 7.5, and “z” is from 0.1 to 0.9).

The composite material can be obtained by: obtaining a cured product by crosslinking (A) a crosslinkable group-containing organic compound, and (B) a silicon-containing compound capable of crosslinking the crosslinkable group-containing organic compound; and heat treating the obtained cured product. Therefore, it follows that another aspect of the present invention is a method for manufacturing a silicon-containing carbon-based composite material represented by the compositional formula: SiOₓC_{y}H_{z}

(wherein “x” is from 0.8 to 1.5, “y” is from 1.4 to 7.5, and “z” is from 0.1 to 0.9),

the method comprising: obtaining a cured product by crosslinking (A) a crosslinkable group-containing organic compound (hereinafter referred to as component (A)), and (B) a silicon-containing compound capable of crosslinking the crosslinkable group-containing organic compound (hereinafter referred to as “component (B)); and heat treating the obtained cured product.

The heat treating is preferably performed at a temperature from 300° C. to 1,500° C. in an inert gas or in a vacuum.

The crosslinkable group can be selected from the group consisting of aliphatic unsaturated groups, epoxy groups, acryl groups, methacryl groups, amino groups, hydroxyl groups, mercapto groups, and halogenated alkyl groups.

Component (A) may have an aromatic group.

Component (A) is preferably an organic compound represented by the following general formula.

(R¹)ₓR²

In this formula, R¹ is a crosslinkable group; “x” is an integer greater than or equal to 1; and R² is an aromatic group with “x” valency.

Component (A) preferably includes silicon atoms.

Component (A) is preferably a siloxane, a silane, a silazane, a carbosilane, or a mixture thereof.

The siloxane is preferably represented by the following average unit formula:

(R³₃SiO_{1/2})ₐ(R³₂SiO_{2/2})_{b}(R³SiO_{3/2})_{c}(SiO_{4/2})_{d}

In this formula, R³ each independently represent a crosslinkable group, a monovalent substituted or unsubstituted saturated aliphatic hydrocarbon group or aromatic hydrocarbon group having from 1 to 20 carbons, an alkoxy group, a hydrogen atom, or a halogen atom. “a”, “b”, “c”, and “d” are numbers that are greater than or equal to 0 and less than or equal to 1, and that satisfy “a”+“b”+“c”+“d”=1. However, “a”, “b”, and “c” cannot be 0 at the same time, and at least one R³ in a molecule is a crosslinkable group.

Component (B) is preferably a siloxane, a silane, a silazane, a carbosilane, or a mixture thereof.

The siloxane is preferably represented by the following average unit formula:

(R³₃SiO_{1/2})ₐ(R³₂SiO_{2/2})_{b}(R³SiO_{3/2})_{c}(SiO_{4/2})_{d}

In this formula, R³ each independently represent a monovalent hydrocarbon group, a hydrogen atom, a halogen atom, an epoxy group-containing organic group, an acryl group- or methacryl group-containing organic group, an amino group-containing organic group, a mercapto group-containing organic group, an alkoxy group, or a hydroxy group. “a”, “b”, “c”, and “d” are numbers that are greater than or equal to 0 and less than or equal to 1, and that satisfy “a”+“b”+“c”+“d”=1. However, “a”, “b”, and “c” cannot be 0 at the same time.

The crosslinking reaction may be carried out via an addition reaction, a condensation reaction, a ring-opening reaction, or a radical reaction.

The cured product may be obtained via a hydrosilylation reaction of component (A) having aliphatic unsaturated groups and component (B) having silicon-bonded hydrogen atoms.

The cured product may be obtained via a hydrosilylation reaction of component (A) having silicon-bonded hydrogen atoms and component (B) having aliphatic unsaturated groups.

The cured product may be obtained by a radical reaction of component (A) having aliphatic unsaturated groups and component (B) having aliphatic unsaturated groups, acryl groups, methacryl groups, or silicon-bonded hydrogen atoms.

The cured product may be obtained by a radical reaction of component (A) having aliphatic unsaturated groups, acryl groups, methacryl groups, or silicon-bonded hydrogen atoms and component (B) having aliphatic unsaturated groups.

The silicon-containing carbon-based composite material of the present invention is preferably amorphous. Additionally, the composite material is preferably a particulate having an average diameter from 5 nm to 50 μm.

The electrode active material of the present invention is constituted by the composite material described above. The electrode active material is preferably constituted by particles having an average diameter from 1 to 50 μm.

The electrode of the present invention includes the electrode active material described above, and can be suitably used for electricity storage devices, especially for lithium or lithium-ion secondary batteries.

The composite material of the present invention has high reversible capacity and stable charge and discharge cycle characteristics, and has high initial charge and discharge efficiency. Therefore, the composite material of the present invention is suitable for an electrode of an electricity storage device, particularly of a lithium or lithium-ion secondary battery. Additionally, the composite material of the present invention uses inexpensive raw materials and can be manufactured via a simple manufacturing process.

The electrode active material of the present invention is suitable for use in an electricity storage device, particularly as an electrode of a lithium or lithium-ion secondary battery. Moreover, the electrode of the present invention can impart high reversible capacity, stable charge and discharge cycle characteristics, and high initial charge and discharge efficiency to a battery. As a result, the electricity storage device of the present invention can have high reversible capacity, stable charge and discharge cycle characteristics, and high initial charge and discharge efficiency.

### BRIEF DESCRIPTION OF THE DRAWINGS

FIG. 1 illustrates a lithium-ion secondary battery that is an example of the electricity storage device of the present invention.

FIG. 2 illustrates a lithium secondary battery that is an example of the electricity storage device of the present invention.

### DESCRIPTION OF EMBODIMENTS

Composite Material

The composite material of the present invention can be obtained by a manufacturing method characterized by obtaining a cured product by: crosslinking (A) a crosslinkable group-containing organic compound, and (B) a silicon-containing compound capable of crosslinking the crosslinkable group-containing organic compound; and heat treating the obtained cured product.

The crosslinkable group in component (A) is not particularly limited provide that it is a crosslinkable group. Examples thereof include aliphatic unsaturated groups, epoxy groups, acryl groups, methacryl groups, amino groups, hydroxyl groups, mercapto groups, and halogenated alkyl groups. Specific examples of the aliphatic unsaturated groups include vinyl groups, propenyl groups, butenyl groups, pentenyl groups, hexenyl groups, and similar alkenyl groups; acetyl groups, propynyl groups, pentynyl groups, and similar alkynyl groups. Specific examples of the epoxy groups include glycidyl groups, glycidoxy groups, epoxycyclohexyl groups, 3-glycidoxypropyl groups, and 2-(3,4-epoxycyclohexyl)ethyl groups. Specific examples of the acryl groups include 3-acryloxypropyl groups. Specific examples of the methacryl groups include 3-methacryloxypropyl groups. Specific examples of the amino groups include 3-aminopropyl groups, and N-(2-aminoethyl)-3-aminopropyl groups. Specific examples of the hydroxyl groups include hydroxyethyl groups, hydroxypropyl groups, and similar hydroxyalkyl groups; and hydroxyphenyl groups and similar hydroxyaryl groups. Specific examples of the mercapto groups include 3-mercaptopropyl groups. Specific examples of the halogenated alkyl groups include 3-chloropropyl groups.

Note that component (A) may be mixture of an organic compound having one crosslinkable group in a molecule and an organic compound having at least two crosslinkable groups in a molecule. In this case, a proportion of the latter compound in the mixture is not particularly limited, but, from the perspective of obtaining excellent crosslinkage, the content is preferably at least 15 mass (weight) % and more preferably at least 30 mass (weight) %.

Component (A) may be silicon-free or may include silicon.

When component (A) is silicon-free, component (A) is preferably an organic compound having at least one aromatic ring in a molecule because forming a graphene structure is facilitated due to excellent efficiency when carbonizing by heating.

Examples of component (A) described above include silicon-free aliphatic hydrocarbon compounds having a crosslinkable group at a molecular terminal and/or in the side molecular chains; silicon-free aliphatic hydrocarbon compounds having a crosslinkable group at a molecular terminal and/or in the side molecular chains and hetero-atoms other than carbon atoms, such as, for example, nitrogen, oxygen, or boron atoms, in the molecular chain; silicon-free aromatic hydrocarbon compounds having a crosslinkable group in a molecule;

and silicon-free cyclic fatty compounds having a crosslinkable group in a molecule and also hetero-atoms other than carbon atoms, such as, for example, nitrogen, oxygen, or boron atoms.

Specific examples of the aliphatic hydrocarbon compounds include compounds represented by the following formulae:

R¹—(CH₂)ₘ—R¹

CH₃—(CH₂)ₘ—(CHR¹)ₙ—CH₃

CH₃—(CH₂)ₘ—(CH═CH)ₙ—CH₃

CH₃—(CH₂)ₘ—(C≡C)ₙ—CH₃

R¹—O(CH₂CH₂O)ₘ(CH₂CH₂CH₂O)ₙ—R¹

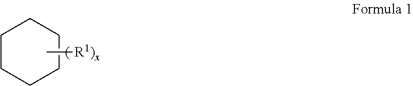

In the formulae, R¹ represents a crosslinkable group, and examples thereof include aliphatic unsaturated groups, epoxy groups, acryl groups, methacryl groups, amino groups, hydroxyl groups, mercapto groups, and halogenated alkyl groups. Specific examples are the same as the groups described above. Additionally, “m” and “n” are integers greater than or equal to 1; and “x” is an integer greater than or equal to 1.

Specific examples of the aromatic hydrocarbon compound include compounds represented by the following general formula:

(R¹)ₓR²

In this formula, R¹ is a crosslinkable group, and examples thereof are the same as the groups described above. Additionally, “x” is an integer greater than or equal to 1. R² represents an aromatic group with “x”-valency. Specifically, in this formula, when “x” is 1, R² represents a monovalent aromatic group, and specific examples thereof include the groups described below.

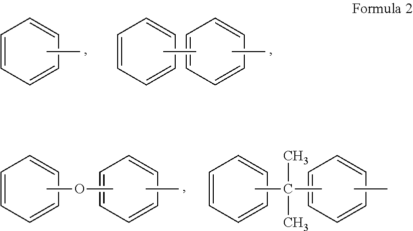

Specific examples of the aromatic hydrocarbon compound described above include α- or β-methylstyrene, α- or β-ethylstyrene, methoxystyrene, phenylstyrene, chlorostyrene, o-, m-, or p-methylstyrene, ethylstyrene, methylsilylstyrene, hydroxystyrene, cyanostyrene, nitrostyrene, aminostyrene, carboxystyrene, sulfoxystyrene, sodium styrenesulfonate, vinylpyridine, vinylthiophene, vinylpyrrolidone, vinylnaphthalene, vinylanthracene, and vinylbiphenyl.

Additionally, in the formula, when “x” is 2, R² represents a bivalent aromatic group, and specific examples thereof include the groups described below.

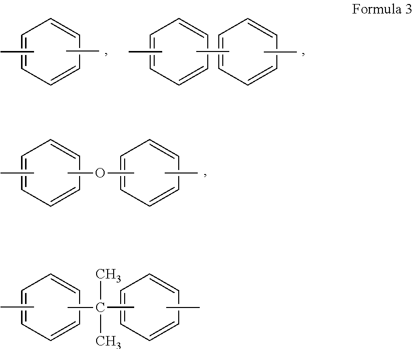

Specific examples of the aromatic hydrocarbon compound described above include divinylbenzene, divinylbiphenyl, vinylbenzylchloride, divinylpyrindine, divinylthiophene, divinylpyrrolidone, divinylnaphthalene, divinylxylene, divinylethylbenzene, and divinylanthracene. The aromatic hydrocarbon compound is preferably divinylbenzene because the pyrolyzing characteristics of the obtained cured product will be superior.

Additionally, in the formula, when “x” is 3, R² represents a trivalent aromatic group, and specific examples thereof include the groups described below.

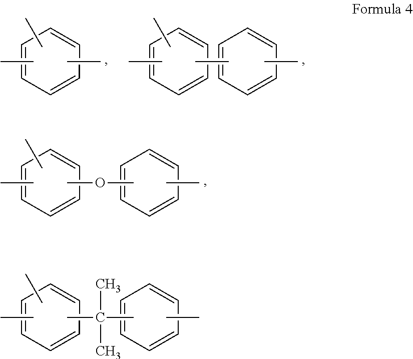

Specific examples of the aromatic hydrocarbon compound described above include trivinylbenzene and trivinylnaphthalene.

Additionally, specific examples of the aromatic compound comprising hetero-atoms include aromatic compounds represented by the following general formula:

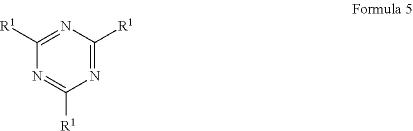

In this formula, R¹ is a crosslinkable group, and examples thereof are the same as the groups described above.

Additionally, specific examples of the cyclic compound having hetero-atoms include cyclic compounds represented by the following general formula:

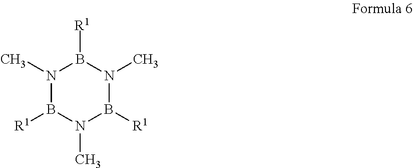

In this formula, R¹ is a crosslinkable group, and examples thereof are the same as the groups described above.

Component (A) including silicon is not particularly limited provided that it has a crosslinkable group, and examples thereof include silicon-containing monomers, oligomers, and polymers. Examples thereof include silanes constituted by structural units having silicon-silicon bonds, silazanes constituted by structural units having silicon-nitrogen-silicon bonds, siloxanes constituted by structural units having silicon-oxygen-silicon bonds, carbosilanes constituted by structural units having silicon-carbon-silicon bonds, and mixtures thereof.

Examples of silanes as the component (A) include those represented by the following average unit formula:

R³₄Si

or the following average unit formula:

(R³₃Si)ₐ(R³₂Si)_{b}(R³Si)_{c}(Si)_{d}

In these formulae, R³ each independently represent the crosslinkable group described above, a monovalent substituted or unsubstituted saturated aliphatic hydrocarbon group or aromatic hydrocarbon group having from 1 to 20 carbons, an alkoxy group, a hydrogen atom, or a halogen atom. “a”, “b”, “c”, and “d” are each 0 or a positive number. However, “a”+“b”+“c”+“d”=1, and at least one and preferably at least two R³ moieties in a molecule are the crosslinkable group described above.

The saturated aliphatic hydrocarbon group is preferably an alkyl group, and the aromatic hydrocarbon group is preferably an aryl group and an aralkyl group.

The alkyl groups are preferably alkyl groups having from 1 to 12 carbons and more preferably alkyl groups having from 1 to 6 carbons. The alkyl groups are preferably any of the following: straight or branched chain alkyl groups, cycloalkyl groups, or cycloalkylene groups (alkyl groups that combine straight or branched chain alkylene groups (preferably methylene groups, ethylene groups, or similar alkylene groups having from 1 to 6 carbons) with carbon rings (preferably rings having from 3 to 8 carbons)).

The straight or branched chain alkyl groups preferably have from 1 to 6 carbons and examples thereof include methyl groups, ethyl groups, n-propyl groups, isopropyl groups, butyl groups, t-butyl groups, pentyl groups, hexyl groups, and the like. Methyl groups are particularly preferable.

The cycloalkyl groups preferably have from 4 to 6 carbons and examples thereof include cyclobutyl groups, cyclopentyl groups, cyclohexyl groups, and the like. Cyclopentyl groups and cyclohexyl groups are particularly preferable.

The aryl groups preferably have from 6 to 12 carbons and examples thereof include phenyl groups, naphthyl groups, and tolyl groups.

The aralkyl groups preferably have from 7 to 12 carbons. Examples of aralkyl groups with from 7 to 12 carbons include benzyl groups, phenethyl groups, and phenylpropyl groups.

The hydrocarbon group may have a substituent and examples of said substituent include fluorine atoms, chlorine atoms, bromine atoms, iodine atoms, and similar halogen atoms; hydroxyl groups; methoxy groups, ethoxy groups, n-propoxy groups, isopropoxy groups, and similar alkoxy groups having from 1 to 6 carbons; amino groups; amide groups; nitro groups; epoxy groups; and the like. The substituent can be bonded at the hydrocarbon chain position, the saturated ring position, or the aromatic ring position.

Examples of the alkoxy groups include methoxy groups, ethoxy groups, n-propoxy groups, and isopropoxy groups.

Examples of the halogen atoms include fluorine atoms, chlorine atoms, bromine atoms, and iodine atoms.

The silane described above can be manufactured by methods known in the art. Examples of methods thereof include the method comprising dehalogenation of halosilanes in the presence of an alkali metal described in Macromolecules, 23, 3423 (1990), etc.; the method comprising anionic polymerization of disilenes described in Macromolecules, 23, 4494 (1990), etc.; the method comprising dehalogenation of halosilanes via electrode reduction described in J. Chem. Soc., Chem. Commun., 1161 (1990); J. Chem. Soc., Chem. Commun., 897 (1992), etc; the method comprising dehalogenation of halosilanes in the presence of magnesium (see WO98/29476, etc.); the method comprising dehydration of hydrosilanes in the presence of metal catalysts (see Japanese Unexamined Patent Application Publication No. H04-334551, etc.), and other methods.

Examples of silazane as component (A) include those represented by the following average unit formula:

(R³₃SiNR⁴)ₐ(R³₂SiNR⁴)_{b}(R³SiNR⁴)_{c}(SiNR⁴)_{d}

In the formula, R³ moieties each independently represent the crosslinkable group described above, a monovalent substituted or unsubstituted saturated aliphatic hydrocarbon group or aromatic hydrocarbon group having from 1 to 20 carbons, an alkoxy group, a hydrogen atom, or a halogen atom. R⁴ represents a hydrogen atom, a monovalent substituted or unsubstituted saturated aliphatic hydrocarbon group or aromatic hydrocarbon group having from 1 to 20 carbons. “a”, “b”, “c”, and “d” are each 0 or a positive number. However, “a”+“b”+“c”+“d”=1, and at least one and preferably at least two R³ in a molecule are the crosslinkable group described above. Here, the saturated aliphatic hydrocarbon group, the aromatic hydrocarbon group, the alkoxy group, and the halogen atoms are the same as those defined above for the silane.

The silazane described above can be prepared by methods known in the art. Examples of methods for preparing the silazane include those methods described in U.S. Pat. Nos. 4,312,970, 4,340,619, 4,395,460, 4,404,153, 4,482,689, 4,397,828, 4,540,803, 4,543,344, 4,835,238, 4,774,312, 4,929,742, and 4,916,200. An alternate method is also described in J. Mater. Sci., 22, 2609 (1987).

Examples of siloxanes as component (A) include those represented by the following average unit formula:

(R³₃SiO_{1/2})ₐ(R³₂SiO_{2/2})_{b}(R³SiO_{3/2})_{c}(SiO_{4/2})_{d}

In this formula, R³ each independently represent a crosslinkable group, a monovalent substituted or unsubstituted saturated aliphatic hydrocarbon group or aromatic hydrocarbon group having from 1 to 20 carbons, an alkoxy group, a hydrogen atom, or a halogen atom. “a”, “b”, “c”, and “d” are numbers that are greater than or equal to 0 and less than or equal to 1, and that satisfy “a”+“b”+“c”+“d”=1. However, “a”, “b”, and “c” cannot be 0 at the same time, and at least one and preferably at least two R³ in a molecule is a crosslinkable group. Here, the saturated aliphatic hydrocarbon group, the aromatic hydrocarbon group, the alkoxy group, and the halogen atoms are the same as those defined above for the silane.

The siloxane described above can be prepared by methods known in the art. The method for preparing the siloxane is not particularly limited, but the most general methods of preparation include hydrolysis of organochlorosilanes. These and other methods are disclosed by Noll in, Chemistry and Technology of Silicones, Chapter 5 (Translated 2nd German Issue, Academic Press, 1968).

Examples of carbosilane as component (A) include those represented by the following average unit formula:

(R³₃SiCR⁵R⁶)ₐ(R³₂SiCR⁵R⁶)_{b}(R³SiCR⁵R⁶)_{c}(SiCR⁵R⁶)_{d}

In the formula, R³ each independently represent the crosslinkable group described above, a monovalent substituted or unsubstituted saturated aliphatic hydrocarbon group or aromatic hydrocarbon group having from 1 to 20 carbons, an alkoxy group, a hydrogen atom, or a halogen atom. R⁵ and R⁶ each independently represent a hydrogen atom, a monovalent substituted or unsubstituted saturated aliphatic hydrocarbon group or aromatic hydrocarbon group having from 1 to 20 carbons. “a”, “b”, “c”, and “d” are each 0 or a positive number. However, “a”+“b”+“c”+“d”=1, and at least one and preferably at least two R³ in a molecule are the crosslinkable group described above. Here, the saturated aliphatic hydrocarbon group, the aromatic hydrocarbon group, the alkoxy group, and the halogen atoms are the same as those defined above for the silane.

The carbosilane described above can be prepared by methods known in the art. Examples of methods for preparing the carbosilanes are described in Macromolecules, 21, 30 (1988) and U.S. Pat. No. 3,293,194.

The forms of the silane, silazane, siloxane, and carbosilane are not particularly limited, and may be solids, liquids, or paste-like forms, but, from the perspectives of handle-ability and the like, are preferably solids.

Of these silicon-based polymer compounds, siloxanes constituted by units having silicon-oxygen-silicon bonds are preferable and polysiloxanes are more preferable in light of the following industrial benefits: the amount of silicon is not excessively low, such compounds have sufficient chemical stability, handling at room temperature in air is easy, raw material costs and fabrication process costs are low, and sufficient cost performance can be obtained.

Component (A) may be one type of the organic compound described above or may be a mixture of two or more types; and furthermore, may comprise a nitrogen-containing monomer such as acrylonitrile or the like as another component. In this case, a content of the nitrogen-containing monomer is preferably not more than 50 mass (weight) %, and more preferably is in a range from 10 to 50 mass (weight) %.

Component (B) is a silicon-containing compound capable of crosslinking component (A). Examples of component (B) described above include siloxanes, silanes, silazanes, carbosilanes, and mixtures thereof. Specific examples include monomers, oligomers, or polymers having Si—O—Si bonds and similar siloxanes; monomers, oligomers, or polymers having silane and Si—Si bonds and similar silanes; monomers, oligomers, or polymers having Si—(CH₂)ₙ—Si bonds and similar silalkylenes; monomers, oligomers, or polymers having Si—(C₆H₄)ₙ—Si or Si—(CH₂CH₂C₆H₄CH₂CH₂)ₙ—Si bonds and similar silarylenes; monomers, oligomers, or polymers having Si—N—Si bonds and similar silazanes; silicon-containing copolymer compounds having at least two types of bonds selected from Si—O—Si bonds, Si—Si bonds, Si—(CH₂)ₙ—Si bonds, Si—(C₆H₄)ₙ—Si bonds, and Si—N—Si bonds; and mixtures thereof. Note that in the formula, “n” is an integer greater than or equal to 1. Component (B) preferably has silicon-bonded hydrogen atoms.

Examples of siloxanes as component (B) include those represented by the following average unit formula: (R⁷₃SiO_{1/2})ₐ(R⁷₂SiO_{2/2})_{b}(R⁷SiO_{3/2})_{c}(SiO_{4/2})_{d}

In this formula, R⁷ each independently represent a monovalent hydrocarbon group, a hydrogen atom, a halogen atom, an epoxy group-containing organic group, an acryl group- or methacryl group-containing organic group, an amino group-containing organic group, a mercapto group-containing organic group, an alkoxy group, or a hydroxy group. “a”, “b”, “c”, and “d” are numbers that are greater than or equal to 0 and less than or equal to 1, and that satisfy “a”+“b”+“c”+“d”=1. However, “a”, “b”, and “c” cannot be 0 at the same time.

Specific examples of the monovalent hydrocarbon groups represented by R⁷ include alkyl groups, alkenyl groups, aralkyl groups, and aryl groups. The alkyl groups are preferably alkyl groups having from 1 to 12 carbons and more preferably alkyl groups having from 1 to 6 carbons. The alkyl groups may be any of the following: straight or branched chain alkyl groups, cycloalkyl groups, or cycloalkylene groups (alkyl groups that combine straight or branched chain alkylene groups (preferably methylene groups, ethylene groups, or similar alkylene groups having from 1 to 6 carbons) with carbon rings (preferably rings having from 3 to 8 carbons)). The straight or branched chain alkyl groups preferably have from 1 to 6 carbons and specific examples thereof include methyl groups, ethyl groups, n-propyl groups, isopropyl groups, butyl groups, t-butyl groups, pentyl groups, and hexyl groups. The cycloalkyl groups preferably have from 4 to 6 carbons and specific examples thereof include cyclobutyl groups, cyclopentyl groups, and cyclohexyl groups. The alkenyl groups preferably have from 2 to 12 carbons, and more preferably from 2 to 6 carbons. Specific examples of the alkenyl groups having from 2 to 6 carbons include vinyl groups, propenyl groups, butenyl groups, pentenyl groups, and hexenyl groups, of which vinyl groups are preferable. The aralkyl groups preferably have from 7 to 12 carbons. Specific examples of the aralkyl groups having from 7 to 12 carbons include benzyl groups, phenethyl groups, and phenylpropyl groups. The aryl groups preferably have from 6 to 12 carbons and specific examples thereof include phenyl groups, naphthyl groups, and tolyl groups. The monovalent hydrocarbon groups may have substituents. Specific examples of such substituents include fluorine atoms, chlorine atoms, bromine atoms, iodine atoms, or other halogens; hydroxyl groups; methoxy groups, ethoxy groups, n-propoxy groups, isopropoxy groups, or similar alkoxy groups. Specific examples of such substituted monovalent hydrocarbon groups include 3-chloropropyl groups, 3,3,3-trifluoropropyl groups, perfluorobutylethyl groups, and perfluorooctylethyl groups.

Specific examples of the halogen atoms represented by R⁷ include fluorine atoms, chlorine atoms, bromine atoms, and iodine atoms, of which chlorine atoms are preferable.

Specific examples of the epoxy group-containing organic groups represented by R⁷ include 3-glycidoxypropyl groups, 4-glycidoxybutyl groups, or similar glycidoxyalkyl groups; 2-(3,4-epoxycyclohexyl)-ethyl groups, 3-(3,4-epoxycyclohexyl)-propyl groups, or similar epoxycyclohexylalkyl groups; and 4-oxiranylbutyl groups, 8-oxiranyloctyl groups, or similar oxiranylalkyl groups. Glycidoxyalkyl groups are preferable and 3-glycidoxypropyl groups are particularly preferable.

Specific examples of the acryl group- or methacryl group-containing organic groups represented by R⁷ include 3-acryloxypropyl groups, 3-methacryloxypropyl groups, 4-acryloxybutyl groups, and 4-methacryloxybutyl groups, of which 3-methacryloxypropyl groups are preferable.

Specific examples of the amino group-containing organic groups represented by R⁷ include 3-aminopropyl groups, 4-aminobutyl groups, and N-(2-aminoethyl)-3-aminopropyl groups, of which 3-aminopropyl groups and N-(2-aminoethyl)-3-aminopropyl groups are preferable.

Specific examples of the mercapto group-containing organic groups represented by R⁷ include 3-mercaptopropyl groups and 4-mercaptobutyl groups.

Specific examples of the alkoxy groups represented by R⁷ include methoxy groups, ethoxy groups, n-propoxy groups, and isopropoxy groups, of which methoxy groups and ethoxy groups are preferable.

In a molecule, at least one group and preferably at least two groups represented by R⁷ are alkenyl groups, hydrogen atoms, halogen atoms, epoxy-containing organic groups, acryl-containing organic groups, methacryl-containing organic groups, amino-containing organic groups, mercapto-containing organic groups, alkoxy groups, or hydroxy groups.

“a”, “b”, “c”, and “d” are numbers that are greater than or equal to 0 and less than or equal to 1, and that satisfy “a”+“b”+“c”+“d”=1. However, “a”, “b”, and “c” cannot be equal to 0 at the same time.

The aforementioned siloxanes may be structured at least from one of the structural units selected from (R⁷₃SiO_{1/2}), (R⁷₂SiO_{2/2}), (R⁷SiO_{3/2}), and (SiO_{4/2}). Specific examples are the following: a straight chain polysiloxane composed of (R⁷₃SiO_{1/2}) and (R⁷₂SiO_{2/2}) units; a cyclic polysiloxane composed of (R⁷₂SiO_{2/2}) units; a branched chain polysiloxane comprising (R⁷SiO_{3/2}) or (SiO_{4/2}) units; a polysiloxane composed of (R⁷₃SiO_{1/2}) and (R⁷SiO_{3/2}) units; a polysiloxane composed of (R⁷₃SiO_{1/2}) and (SiO_{4/2}) units; a polysiloxane composed of (R⁷SiO_{3/2}) and (SiO_{4/2}) units; a polysiloxane composed of (R⁷₂SiO_{2/2}) and (R⁷SiO_{3/2}) units; a polysiloxane composed of (R⁷₂SiO_{2/2}) and (SiO_{4/2}) units; a polysiloxane composed of (R⁷₃SiO_{1/2}), (R⁷₂SiO_{2/2}), and (R⁷₂SiO_{3/2}) units; a polysiloxane composed of (R⁷₃SiO_{1/2}), (R⁷₂SiO_{2/2}), and (SiO_{4/2}) units; a polysiloxane composed of (R⁷₃SiO_{1/2}), (R⁷SiO_{3/2}), and (SiO_{4/2}) units; a polysiloxane composed of (R⁷₂SiO_{2/2}), (R⁷SiO_{3/2}), and (SiO_{4/2}) units; and a polysiloxane composed of (R⁷₃SiO_{1/2}), (R⁷₂SiO_{2/2}), (R⁷SiO_{3/2}), and (SiO_{4/2}) units. The number of repetitions of the structural units represented by each of (R⁷₃SiO_{1/2}), (R⁷₂SiO_{2/2}), (R⁷SiO_{3/2}), and (SiO_{4/2}) is preferably within a range from 1 to 10,000, more preferably within a range from 1 to 1,000, and even more preferably within a range from 3 to 500.

The siloxanes described above can be prepared by methods known in the art. The method for preparing these siloxanes is not particularly limited, but the most general methods include hydrolysis of organochlorosilanes. These and other methods are disclosed by Noll in, Chemistry and Technology of Silicones, Chapter 5 (Translated 2nd German Issue, Academic Press, 1968).

The siloxanes described above may be silicon-containing copolymer compounds with polymers. Examples of silicon-containing copolymer compounds that can be used as the siloxanes include silicon-containing copolymer compounds having Si—O—Si bonds and Si—Si bonds; silicon-containing copolymer compounds having Si—O—Si bonds and Si—N—Si bonds; silicon-containing copolymer compounds having Si—O—Si bonds and Si—(CH₂)ₙ—Si bonds; silicon-containing copolymer compounds having Si—O—Si bonds and Si—(C₆H₄)ₙ—Si bonds or Si—(CH₂CH₂C₆H₄CH₂CH₂)ₙ—Si bonds; and the like. In the formulae, “n” has the same meaning as defined above.

Furthermore, the silanes can be represented by the following general formula:

R⁷₄Si

or the following average unit formula:

(R⁷₃Si)ₐ(R⁷₂Si)_{b}(R⁷Si)_{c}(Si)_{d}

In the formulae, R⁷ each independently represent a monovalent hydrocarbon group, a hydrogen atom, a halogen atom, an epoxy group-containing organic group, an acryl group- or methacryl group-containing organic group, an amino group-containing organic group, a mercapto group-containing organic group, an alkoxy group, or a hydroxy group. In one molecule, at least one group and preferably at least two groups represented by R⁷ are alkenyl groups, hydrogen atoms, halogen atoms, epoxy-containing organic groups, acryl-containing organic groups, methacryl-containing organic groups, amino-containing organic groups, mercapto-containing organic groups, alkoxy groups, or hydroxy groups. “a”, “b”, “c”, and “d” are numbers that are greater than or equal to 0 and less than or equal to 1, and that satisfy “a”+“b”+“c”+“d”=1. However, “a”, “b”, and “c” cannot be equal to 0 at the same time.

The silanes are represented by the general formula: R⁷₄Si, or structured from at least one of the structural units selected from (R⁷₃Si)), (R⁷₂Si), (R⁷Si), and (Si). Specific examples are the following: a straight chain polysilane composed of (R⁷₃Si) and (R⁷₂Si) units; a cyclic polysilane composed of (R⁷₂Si) units; a branched chain polysilane (polysiline) comprising (R⁷Si) or (Si) units; a polysilane composed of (R⁷₃Si) and (R⁷Si) units; a polysilane composed of (R⁷₃Si) and (Si) units; a polysilane composed of (R⁷Si) and (Si) units; a polysilane composed of (R⁷₂Si) and (R⁷Si) units; a polysilane composed of (R⁷₂Si) and (Si) units; a polysilane composed of (R⁷₃Si), (R⁷₂Si), and (R⁷Si) units; a polysilane composed of (R⁷₃Si), (R⁷₂Si), and (Si) units; a polysilane composed of (R⁷₃Si), (R⁷Si), and (Si) units; a polysilane composed of (R⁷₂Si), (R⁷Si), and (Si) units; or a polysilane composed of (R⁷₃Si), (R⁷₂Si), (R⁷Si), and (Si) units. The number of repetitions of the structural units represented by each of (R⁷₃Si), (R⁷₂Si), (R⁷Si), and (Si) is preferably within a range from 2 to 10,000, more preferably within a range from 3 to 1,000, and even more preferably within a range from 3 to 500.

The silanes described above can be manufactured by methods known in the art. Examples of methods thereof include the method comprising dehalogenation of halosilanes in the presence of an alkali metal described in Macromolecules, 23, 3423 (1990), etc.; the method comprising anionic polymerization of disilenes described in Macromolecules, 23, 4494 (1990), etc.; the method comprising dehalogenation of halosilanes via electrode reduction described in J. Chem. Soc., Chem. Commun., 1161 (1990); J. Chem. Soc., Chem. Commun., 897 (1992), etc; the method comprising dehalogenation of halosilanes in the presence of magnesium (see WO98/29476, etc.); the method comprising dehydration of hydrosilanes in the presence of metal catalysts (see Japanese Unexamined Patent Application Publication No. H04-334551, etc.), and other methods.

The silanes described above may be silicon-containing copolymer compounds with other polymers. Examples of silicon-containing copolymer compounds that can be used as the silanes include silicon-containing copolymer compounds having Si—Si bonds and Si—O—Si bonds; silicon-containing copolymer compounds having Si—Si bonds and Si—N—Si bonds; silicon-containing copolymer compounds having Si—Si bonds and Si—(CH₂)ₙ—Si bonds; silicon-containing copolymer compounds having Si—Si bonds and Si—(C₆H₄)ₙ—Si bonds or Si—(CH₂CH₂C₆H₄CH₂CH₂)ₙ—Si bonds; and the like.

Examples of other silanes include silicon-containing compounds represented by the following general formula:

[(R⁸)₂HSi]ₑR⁹

In this formula, R⁸ each represent substituted or unsubstituted monovalent hydrocarbon groups. “e” is an integer greater than or equal to 2, and R⁹ is an “e”-valent organic group. In this formula, examples of the monovalent hydrocarbon groups represented by R⁸ are the same as the monovalent hydrocarbon groups described as examples for R⁷. “e” is an integer greater than or equal to 2, preferably an integer in a range from 2 to 6. When R⁹ is an “e”-valent organic group and “e” is equal to 2, R⁹ is a bivalent organic group. Specific examples thereof include alkylene groups, alkenylene groups, alkyleneoxyalkylene groups, arylene groups, aryleneoxyarylene groups, and arylene-alkylene-arylene groups. Even more specific examples include the groups represented by the following formulae:

—CH₂CH₂—, —CH₂CH₂CH₂—, —CH₂CH(CH₃)—, —CH═CH—, —C≡C—, —CH₂CH₂OCH₂CH₂—, —CH₂CH₂CH₂OCH₂CH₂—,

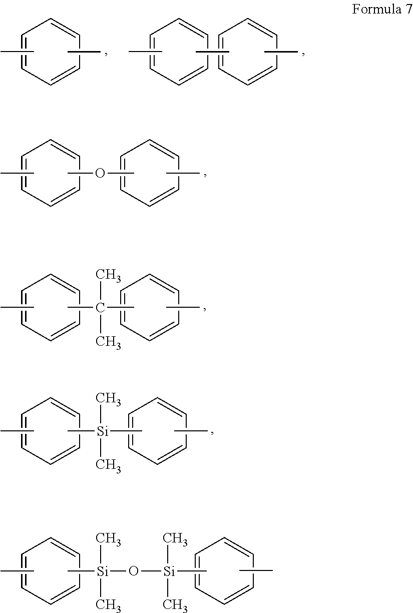

When “e” is equal to 3, R⁹ is a trivalent organic group. Specific examples thereof include the groups represented by the following formulae:

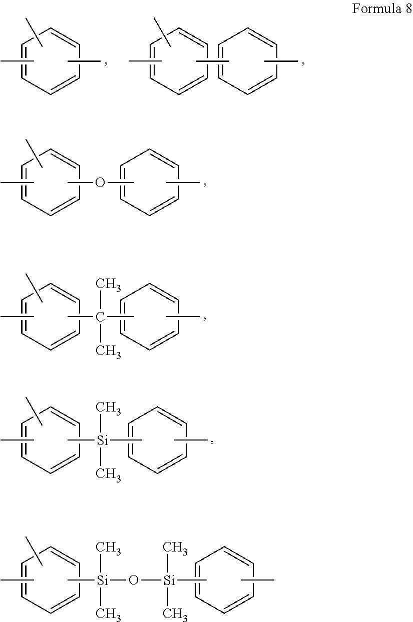

Examples of the silazanes are those represented, for example, by the following average unit formula:

(R⁷₃SiNR¹⁰)ₐ(R⁷₂SiNR¹⁰)_{b}(R⁷SiNR¹⁰)_{c}(SiNR¹⁰)_{d}

In this formula, R⁷ each independently represent a monovalent hydrocarbon group, a hydrogen atom, a halogen atom, an epoxy group-containing organic group, an acryl group- or methacryl group-containing organic group, an amino group-containing organic group, a mercapto group-containing organic group, an alkoxy group, or a hydroxy group. In one molecule, at least one group and preferably at least two groups represented by R⁷ are alkenyl groups, hydrogen atoms, halogen atoms, epoxy-containing organic groups, acryl-containing organic groups, methacryl-containing organic groups, amino-containing organic groups, mercapto-containing organic groups, alkoxy groups, or hydroxy groups. R¹⁰ is a hydrogen atom or a substituted or unsubstituted monovalent hydrocarbon group. “a”, “b”, “c”, and “d” are numbers that are greater than or equal to 0 and less than or equal to 1, and that satisfy “a”+“b”+“c”+“d”=1. However, “a”, “b”, and “c” cannot be equal to 0 at the same time. Examples of the monovalent hydrocarbon groups represented by R¹⁰ are the same as the examples of the monovalent hydrocarbon groups represented by R⁷. R¹⁰ are preferably hydrogen atoms or alkyl groups, and particularly are preferably hydrogen atoms or methyl groups.

The silazanes contain units selected from at least one of the following structural units: (R⁷₃SiNR¹⁰), (R⁷₂SiNR¹⁰), (R⁷SiNR¹⁰), and (SiNR¹⁰). Specific examples are the following: a straight chain polysilazane composed of) (R⁷₃SiNR¹⁰) and (R⁷₂SiNR¹⁰) units; a cyclic polysilazane composed of (R⁷₂SiNR¹⁰) units; a branched chain polysilazane comprising (R⁷SiNR¹⁰) or (SiNR¹⁰) units; a polysilazane composed of (R⁷₃SiNR¹⁰) and (R⁷SiNR¹⁰) units; a polysilazane composed of (R⁷₃SiNR¹⁰) and (SiNR¹⁰) units; a polysilazane composed of (R⁷SiNR¹⁰) and (SiNR¹⁰) units; a polysilazane composed of (R⁷₂SiNR¹⁰) and (R⁷SiNR¹⁰) units; a polysilazane composed of (R⁷₂SiNR¹⁰) and (SiNR¹⁰) units; a polysilazane composed of (R⁷₃SiNR¹⁰), (R⁷₂SiNR¹⁰), and (R⁷SiNR¹⁰) units; a polysilazane composed of (R⁷₃SiNR¹⁰), (R⁷₂SiNR¹⁰), and (SiNR¹⁰) units; a polysilazane composed of (R⁷₃SiNR¹⁰), (R⁷SiNR¹⁰), and (SiNR¹⁰) units; a polysilazane composed of (R⁷₂SiNR¹⁰), (R⁷SiNR¹⁰), and (SiNR¹⁰) units; and a polysilazane composed of (R⁷₃SiNR¹⁰, (R⁷₂SiNR¹⁰), (R⁷SiNR¹⁰), and (SiNR¹⁰) units. The number of repetitions of the structural units represented by each of (R⁷₃SiNR¹⁰), (R⁷₂SiNR¹⁰), (R⁷SiNR¹⁰), and (SiNR¹⁰) is preferably within a range from 2 to 10,000, more preferably within a range from 3 to 1,000, and even more preferably within a range from 3 to 500.

The silazanes described above can be prepared by methods known in the art. Examples of methods for preparing the silazanes include those methods described in U.S. Pat. Nos. 4,312,970, 4,340,619, 4,395,460, 4,404,153, 4,482,689, 4,397,828, 4,540,803, 4,543,344, 4,835,238, 4,774,312, 4,929,742, and 4,916,200. An alternate method is also described in J. Mater. Sci., 22, 2609 (1987).

The silazanes described above may be silicon-containing copolymer compounds with other polymers. Examples of silicon-containing copolymer compounds that can be used as the polysilazanes include silicon-containing copolymer compounds having Si—N—Si bonds and Si—O—Si bonds; silicon-containing copolymer compounds having Si—N—Si bonds and Si—Si bonds; silicon-containing copolymer compounds having Si—N—Si bonds and Si—(CH₂)ₙ—Si bonds; silicon-containing copolymer compounds having Si—N—Si bonds and Si—(C₆H₄)ₙ—Si bonds or Si—(CH₂CH₂C₆H₄CH₂CH₂)ₙ—Si bonds; and the like. In the formulae, “n” has the same meaning as defined above.

The carbosilanes are represented, for example, by the following average unit formula:

(R⁷₃SiR¹¹)ₐ(R⁷₂SiR¹¹)_{b}(R⁷SiR¹¹)_{c}(SiR)_{d}

In this formula, R⁷ moieties each independently represent a monovalent hydrocarbon group, a hydrogen atom, a halogen atom, an epoxy group-containing organic group, an acryl group- or methacryl group-containing organic group, an amino group-containing organic group, a mercapto group-containing organic group, an alkoxy group, or a hydroxy group. In one molecule, at least one group and preferably at least two groups represented by R⁷ are alkenyl groups, hydrogen atoms, halogen atoms, epoxy-containing organic groups, acryl-containing organic groups, methacryl-containing organic groups, amino-containing organic groups, mercapto-containing organic groups, alkoxy groups, or hydroxy groups. R¹¹ is an alkylene group or an arylene group. “a”, “b”, “c”, and “d” are numbers that are greater than or equal to 0 and less than or equal to 1, and that satisfy “a”+“b”+“c”+“d”=1. However, “a”, “b”, and “c” cannot be equal to 0 at the same time. The alkylene group represented by R¹¹ may be represented, for example, by the formula: —(CH₂)ₙ—, and the arylene group represented by R¹¹ can be represented, for example, by the formula: —(C₆H₄)ₙ—. In the formulae, “n” has the same meaning as defined above.

The carbosilanes are structured from at least one of the structural units represented by the following: (R⁷₃SiR¹¹), (R⁷₂SiR¹¹), (R⁷SiR¹¹), and (SiR¹¹). Specific examples include a straight chain polycarbosilane composed of (R⁷₃SiR¹¹) and (R⁷₂SiR¹¹) units; a cyclic polycarbosilane composed of (R⁷₂SiR¹¹) units; a branched chain polycarbosilane comprising (R⁷SiR¹¹) or (SiR¹¹) units; a polycarbosilane composed of (R⁷₃SiR¹¹) and (R⁷SiR¹¹) units; a polycarbosilane composed of (R⁷₃SiR¹¹) and (SiR¹¹) units; a polycarbosilane composed of (R⁷SiR¹¹) and (SiR¹¹) units; a polycarbosilane composed of (R⁷₂SiR¹¹) and (R⁷SiR¹¹) units; a polycarbosilane composed of (R⁷₂SiR¹¹) and (SiR¹¹) units; a polycarbosilane composed of (R⁷₃SiR¹¹), (R⁷₂SiR¹¹), and (R⁷SiR¹¹) units; a polycarbosilane composed of (R⁷₃SiR¹¹), (R⁷₂SiR¹) and (SiR¹¹) units; a polycarbosilane composed of (R⁷₃SiR¹¹), and (SiR¹¹) units; a polycarbosilane composed of (R⁷₂SiR¹¹), (R⁷SiR¹¹), and (SiR¹¹) units; a polycarbosilane composed of (R⁷₃SiR¹¹), (R⁷₂SiR¹¹), (R⁷SiR¹¹), and (SiR¹¹) units; and similar structural units. The number of repetitions of the structural units represented by each of (R⁷₃SiR¹¹), (R⁷₂SiR¹¹), (R⁷SiR¹¹), and (SiR¹¹) is preferably within a range from 2 to 10,000, more preferably within a range from 3 to 1,000, and even more preferably within a range from 3 to 500.

The carbosilanes described above can be prepared by methods known in the art. Examples of methods for preparing the carbosilanes are described in Macromolecules, 21, 30 (1988) and U.S. Pat. No. 3,293,194.

The carbosilanes described above may be silicon-containing copolymer compounds with other polymers. Examples of silicon-containing copolymer compounds that can be used as the carbosilanes include silicon-containing copolymer compounds having Si—(CH₂)ₙ—Si bonds and Si—O—Si bonds; silicon-containing copolymer compounds having Si—(CH₂)ₙ—Si bonds and Si—Si bonds; silicon-containing copolymer compounds having Si—(CH₂)ₙ—Si bonds and Si—N—Si bonds; silicon-containing copolymer compounds having Si—(CH₂)ₙ—Si bonds and Si—(C₆H₄)ₙ—Si bonds; silicon-containing copolymer compounds having Si—(C₆H₄)ₙ—Si bonds and Si—O—Si bonds; silicon-containing copolymer compounds having Si—(C₆H₄)ₙ—Si bonds and Si—Si bonds; silicon-containing copolymer compounds having Si—(C₆H₄)ₙ—Si bonds or Si—(CH₂CH₂C₆H₄CH₂CH₂)ₙ—Si bonds and Si—N—Si bonds; and the like. In the formulae, “n” has the same meaning as defined above.

The component (B) is preferably a siloxane and more preferably a polysiloxane represented by the following average unit formula:

(R⁷₃SiO_{1/2})ₐ(R⁷₂SiO_{2/2})_{b}(R⁷SiO_{3/2})_{c}(SiO_{4/2})_{d}

In this formula, R⁷ each independently represent a monovalent hydrocarbon group, a hydrogen atom, a halogen atom, an epoxy group-containing organic group, an acryl group- or methacryl group-containing organic group, an amino group-containing organic group, a mercapto group-containing organic group, an alkoxy group, or a hydroxy group. “a”, “b”, “c”, and “d” are numbers that are greater than or equal to 0 and less than or equal to 1, and that satisfy “a”+“b”+“c”+“d”=1. However, “a”, “b”, and “c” cannot be 0 at the same time.

Specific examples of the crosslinking reaction include addition reactions such as a hydrosilylation reaction, a Michael addition reaction, a Diels-Alder reaction, and the like; condensation reactions such as dealcoholization, dehydrogenation, dewatering, deamination, and the like; ring-opening reactions such as epoxy ring-opening, ester ring-opening, and the like; and radical reactions initiated by a peroxide, UV, or the like. Particularly, when component (A) has aliphatic unsaturated groups and component (B) has silicon-bonded hydrogen atoms, a mixture thereof can be hydrosilylation reacted in the presence of a hydrosilylation-reaction catalyst.

Specific examples of the hydrosilylation-reaction catalyst include fine platinum powder, platinum black, fine platinum-carrying silica powder, fine platinum-carrying activated carbon, chloroplatinic acid, platinum tetrachloride, an alcoholic solution of chloroplatinic acid, an olefin complex of platinum, and an alkenylsiloxane complex of platinum. The amount in which the hydrosilylation-reaction catalyst can be used is not particularly limited. However, the catalyst is preferably used in such an amount that, in terms of mass (weight), the content of metal atoms in the catalyst is in a range from 0.1 to 1,000 ppm, and more preferably in a range from 1 to 500 ppm, with respect to a total weight of components (A) and (B).

When component (A) has aliphatic unsaturated groups and component (B) has silicon-bonded hydrogen atoms or when component (A) has silicon-bonded hydrogen atoms and component (B) has aliphatic unsaturated groups, the respective amounts thereof are not particularly limited. However, the contents are such that the silicon-bonded hydrogen atoms in component (B) or (A) are in a range from 0.1 to 50 moles, preferably in a range from 0.1 to 30 moles, and more preferably in a range from 0.1 to 10 moles, per one mole of the aliphatic unsaturated groups in component (A) or (B). A reason for this is because when the amount of the silicon-bonded hydrogen atoms is less than the lower limit of the range described above, the carbonization yield when baking the obtained cured product will tend to decline. On the other hand, when the amount exceeds the range described above, the characteristics as an electrode active material of the silicon-containing carbon-based composite material obtained by baking the obtained cured product will tend to decline.

When component (A) comprises aliphatic unsaturated groups and component (B) comprises aliphatic unsaturated groups, acryl groups, methacryl groups, or silicon-bonded hydrogen atoms and when component (A) comprises aliphatic unsaturated groups, acryl groups, methacryl groups, or silicon-bonded hydrogen atoms and component (B) comprises aliphatic unsaturated groups, a mixture thereof can be radical reacted by a radical initiator using heat and/or light.

Specific examples of the radical initiator include dialkyl peroxides, diacyl peroxides, peroxy esters, peroxy dicarbonates, and similar organic peroxides; and organic azo compounds. Specific examples of the organic peroxides include dibenzoyl peroxide, bis-p-chlorobenzoyl peroxide, bis-2,4-dichlorobenzoyl peroxide, di-t-butyl peroxide, dicumyl peroxide, t-butyl perbenzoate, 2,5-bis(t-butyl peroxy)-2,3-dimethylhexane, t-butyl peracetate, bis(o-methylbenzoyl peroxide), bis(m-methylbenzoyl peroxide), bis(p-methylbenzoyl peroxide), 2,3-dimethylbenzoyl peroxide, 2,4-dimethylbenzoyl peroxide, 2,6-dimethylbenzoyl peroxide, 2,3,4-trimethylbenzoyl peroxide, 2,4,6-trimethylbenzoyl peroxide, and similar methyl group-substituted benzoyl peroxides; t-butyl perbenzoate, dicumyl peroxide, 2,5-dimethyl-2,5-di-(t-butylperoxy)hexane, t-butylperoxy isopropyl monocarbonate, and t-butyl peroxyacetate; and mixtures thereof. Additionally, specific examples of the organic azo compounds include 2,2′-azobisisobutyronitrile, 2,2′-azobis(4-methoxy-2,4-dimethylvaleronitrile, 2,2′-azobis(2,4-dimethylvaleronitrile), 2,2′-azobis-isobutylvaleronitrile, and 1,1′-azobis(1-cyclohexanecarbonitrile).

The amount in which the radical initiator can be used is not particularly limited, but is preferably in a range from 0.1 to 10 mass (weight) %, and more preferably in a range from 0.5 to 5 mass (weight) %, with respect to the total weight of components (A) and (B).

When component (A) comprises aliphatic unsaturated groups and component (B) comprises aliphatic unsaturated groups, acryl groups, methacryl groups, or silicon-bonded hydrogen atoms or when component (A) comprises aliphatic unsaturated groups, acryl groups, methacryl groups, or silicon-bonded hydrogen atoms and component (B) comprises aliphatic unsaturated groups, the amounts thereof are not particularly limited. However, the contents are such that the aliphatic unsaturated groups, acryl groups, methacryl groups, or silicon-bonded hydrogen atoms in one of the components are in a range from 0.1 to 50 moles, preferably in a range from 0.1 to 30 moles, and more preferably in a range from 0.1 to 10 moles, per one mole of the aliphatic unsaturated groups in the other of the components. A reason for this is because when the amount of the aliphatic unsaturated groups, the acryl groups, the methacryl groups, or the silicon-bonded hydrogen atoms is less than the lower limit of the range described above, the carbonization yield when baking the obtained cured product will tend to decline. On the other hand, when the amount exceeds the range described above, the characteristics as an electrode active material of the silicon-containing carbon-based composite material obtained by baking the obtained cured product will tend to decline.

When forming the cured product obtained by crosslinking components (A) and (B), the cured product is formed, for example, by manufacturing according to methods I or II described below, and then subjecting the product to a step of heat treating (baking).

I: After mixing components (A) and (B), the mixture is precured at a temperature not greater than 300° C., and preferably at a temperature from 60° C. to 300° C. The subsequent baking step may be carried out at this point or may be carried out after pulverizing the obtained precured mixture so that an average diameter of particles thereof is from 0.1 to 30 μm and preferably from 1 to 20 μm.
II: When forming the cured product into spherical particles, for example, a crosslinkable composition comprising components (A) and (B) is preferably crosslinked by spraying said crosslinkable composition into hot air or by emulsifying or dispersing said crosslinkable composition in a non-compatible medium.

When one of components (A) and (B) has aliphatic unsaturated groups and the other has silicon-bonded hydrogen atoms, fine particles of the cured product can be obtained by spraying a crosslinkable composition comprising components (A), (B), and the hydrosilylation-reaction catalyst in particulate form into hot-air, and crosslinking by hydrosilylation reaction.

On the other hand, fine particles of the cured product can be formed by adding a crosslinkable composition comprising components (A), (B), and the hydrosilylation-reaction catalyst to an aqueous solution of an emulsifier, emulsifying by agitation to form fine particles of the crosslinkable composition, and, thereafter, crosslinking by hydrosilylation reaction.

The emulsifier is not particularly limited, and specific examples thereof include ionic surfactants, nonionic surfactants, and mixtures of ionic surfactants and nonionic surfactants. Particularly, from the perspective of obtaining excellent uniform dispersion and stability of the oil-in-water emulsion produced by mixing the crosslinkable composition and water, the emulsifier is preferably a mixture of one or more types of ionic surfactant and one or more types of nonionic surfactant.

Moreover, by using silica (colloidal silica) or a metallic oxide such as titanium oxide in combination with the emulsifier and carbonizing while the silica is retained on the surface of the cured product particles, a stable layer can be formed on the carbon surface, carbonization yield can be increased, and surface oxidation occurring when allowing the carbon material to sit can be suppressed.

The diameter of the cured product particles is not particularly limited, but in order to form a silicon-containing carbon-based composite material, through baking, with an average diameter from 1 to 20 μm, which is suitable for an electrode active material, the average diameter is preferably in a range from 5 to 30 μm, and more preferably is in a range from 5 to 20 μm.

Because the crosslinking of the cured product particles obtained as described above can be further promoted and the carbonization yield via baking can be increased, the cured product particles are preferably further subjected to heat treating in air at a temperature from 150° C. to 300° C.

The silicon-containing carbon-based composite material of the present invention can be obtained via a process of heat treating (baking) the cured product of components (A) and (B).

The baking conditions are not particularly limited, but baking is preferably carried out in an inert gas or in a vacuum at a temperature from 300° C. to 1,500° C. Examples of the inert gas include nitrogen, helium, and argon. Note that the inert gas may comprise hydrogen gas or similar reducing gases. The baking temperature is more preferably in a range from 500° C. to 1,000° C. Baking time is not particularly limited, but can be set to a range from 10 minutes to 10 hours, and preferably is set to a range from 30 minutes to 3 hours.

The heating method and type of the carbonization furnace is not particularly limited, and carbonization can be carried out in a fixed-bed type or a fluidized-bed type carbonization furnace, provided that the furnace is capable of heating the product to an appropriate temperature. Specific examples of the carbonization furnace include Reidhammer furnace, tunnel-type furnace, single-type furnace, oxynon furnace, a roller hearth kiln, a pusher kiln, batch type rotary kiln, and continuous rotary kiln and the like.

If a continuous furnace such as a roller hearth kiln, pusher kiln, and continuous rotary kiln is used, the step of forming a cured product by a crosslinking reaction between components (A) and (B) and the step of baking the cured product can be continuously performed. Furthermore, the step of forming the cured product by a crosslinking reaction of components (A) and (B), the baking step, and the surface coating treatment step such as sputtering and thermal chemical vapor deposition can also be continuously performed in a continuous furnace. If a continuous furnace such as a roller hearth kiln, pusher kiln, or continuous rotary kiln is used, the concentration of oxygen in each process environment can be strictly controlled, so there is an advantage that the amount of oxygen atoms and hydrogen atoms in the silicon-containing carbon-based composite material that is obtained can be easily controlled and adjusted.

The silicon-containing carbon-based composite material of the present invention, obtained as described above, is characterized by having a chemical composition represented by the formula: SiOₓC_{y}. In this formula, “x” is from 0.8 to 1.5, preferably from 0.8 to 1.4, more preferably from 0.8 to 1.3, and even more preferably from 0.9 to 1.2. “y” is in a range from 1.4 to 7.5, preferably from 1.7 to 7.0, more preferably from 2.0 to 7.0, and even more preferably from 2.5 to 4.5. “z” is in a range from 0.1 to 0.9, preferably from 0.2 to 0.9, and more preferably from 0.3 to 0.8. When the chemical composition are within the ranges described above, reversible capacity and charge and discharge cycle characteristics will be enhanced and, particularly, initial charge and discharge efficiency will be enhanced.

The chemical composition of the silicon-containing carbon-based composite material can be controlled by pre-adjusting ratios of oxygen atoms, carbon atoms, and hydrogen atoms per one silicon atom in the cured product by changing the type of component (A) and/or component (B) used, and the volume ratio of component (A) to component (B) when curing. Component (A) preferably includes silicon atoms, and component (A) and/or component (B) preferably has silicon atom bonded aromatic hydrocarbon groups because control of the value of “y” after baking is facilitated when an aromatic hydrocarbon group bonded to a silicon atom is present. Additionally, the values of “x”, “y” and “z” can be controlled by adjusting the heat treating atmosphere, flow rate of the inert gas, rate of temperature increase, and heat treating time, when baking.

The silicon-containing carbon-based composite material preferably has oxygen atoms and carbon atoms bonded to the silicon atoms, and an amorphous structure. The structure described above can be confirmed by ²⁹Si MAS NMR or an X-ray diffraction analysis. If the silicon-containing carbon-based composite material is crystallized, the charge and discharge cycle characteristics and the initial charging and discharging efficiency may decline.

The surface of the silicon-containing carbon-based composite material of the present invention may be further subjected to a surface coating treatment by metal or carbon. However, the carbon atoms in the surface coating carbon phase are not included in “y” of the compositional formula described above.

The method of coating the surface of the silicon-containing carbon-based composite material with carbon can be selected as desired. For example, a carbon layer derived from a vapor deposition carbon source (D1) may be thermal chemical vapor deposited on the surface of the silicon-containing carbon-based composite material in a non-oxidation atmosphere at a temperature of 800° C. or higher. Additionally, a silicon-containing carbon-based composite material covered with a carbon phase derived from an organic material carbonized by heating can be obtained by mixing an organic material carbonized by heating (D2) and the silicon-containing carbon-based composite material, and then baking the obtained mixture.

The apparatus used for the thermal chemical vapor deposition is not particularly limited provided that it has means for heating to not less than 800° C. in a non-oxidation atmosphere, and may be appropriately selected depending on the purpose thereof. Apparatuses using continuous methods and/or batch methods can be used, and specific examples thereof include fluidized bed-furnaces, revolving furnaces, vertical moving bed furnaces, tunnel furnaces, batch furnaces, batch-type rotary kilns, and continuous rotary kilns.

Specific examples of the vapor deposition carbon source (D1) used in the thermal chemical vapor deposition include methane, ethane, ethylene, acetylene, propane, butane, butene, pentane, isobutane, hexane, and similar aliphatic hydrocarbons or mixtures thereof; benzene, divinylbenzene, monovinylbenzene, ethylvinylbenzene, toluene, xylene, styrene, ethylbenzene, diphenylmethane, naphthalene, phenol, cresol, nitrobenzene, chlorobenzene, indene, coumarone, pyridine, anthracene, phenanthrene, and similar aromatic hydrocarbons; gas light oil, creosote oil, anthracene oil, or cracked naphtha tar oil obtained in a tar distillation process; exhaust gas produced in the baking process; and mixtures thereof. Generally, methane or acetylene is used.

The non-oxidation atmosphere can be formed by introducing the vapor deposition carbon source gas or flash gas thereof; argon gas, helium gas, hydrogen gas, nitrogen gas, or similar non-oxidizing gases; or a gas mixture thereof into the thermal chemical vapor deposition apparatus.

Baking may be carried out in the same way when mixing the organic material carbonized by heating (D2) and the silicon-containing carbon-based composite material and then baking to obtain a silicon-containing carbon-based composite material coated with a carbon phase derived from the organic material carbonized by heating. Specific examples of the organic material carbonized by heating (D2) include paraffin that is in a liquid or a wax-like state at room temperature; polyethylene, polypropylene, polystyrene, polymethyl methacrylate, urethane resins, AS resins, ABS resins, polyvinyl chloride, polyacetal, aromatic polycarbonate resins, aromatic polyester resins, coal tar, phenolic resins, epoxy resins, urea resins, melamine resins, fluoro resins, imide resins, urethane resins, furan resins, and mixtures thereof. Among these, aromatic polycarbonate resins, aromatic polyester resins, coal tar, phenolic resins, fluoro resins, imide resin, furan resins, and similar high molecular aromatic compounds and melamine resins are preferable. This is because forming a graphene structure is facilitated due to the excellent efficiency when carbonizing by heating.

When coating the surface of the silicon-containing carbon-based composite material with carbon, an amount of the carbon applied is preferably from 0.5 to 50 mass (weight) %, more preferably from 1 to 30 mass (weight) %, and even more preferably from 1 to 20 mass (weight) % of the mass (weight) of the silicon-containing carbon-based composite material. When the amount is within this range, even when using the silicon-containing carbon-based composite material alone as the electrode active material, the silicon-containing carbon-based composite material will have suitable conductivity, and declines in the charging and discharging capacity of the electrode can be suppressed.

The method of coating the surface of the silicon-containing carbon-based composite material with metal can be selected as desired. For example, a metal coating of gold, silver, copper, iron, zinc, platinum, aluminum, cobalt, nickel, titanium, Palladium, stainless steel, and the like can be formed on the surface of the silicon-containing carbon-based composite material by vacuum deposition, sputtering, electroplating, or electroless plating. Of these, nickel and copper are preferable as a surface coating metals.

The silicon-containing carbon-based composite material of the present invention can be constituted by particles having an average diameter from 5 nm to 50 μm. The average diameter is preferably from 10 nm to 40 μm, more preferably from 100 nm to 30 μm, and even more preferably from 1 μm to 20 μm.

The silicon-containing carbon-based composite material of the present invention can be used as the electrode active material of the present invention. The electrode active material of the present invention can be in a particulate form and, in this case, the average diameter thereof is preferably from 1 to 50 μm, more preferably from 1 to 40 μm, and even more preferably from 1 to 30 μm.

The electrode active material comprising the silicon-containing carbon-based composite material of the present invention has high reversible capacity and stable charge and discharge cycle characteristics, and can be used in the manufacturing of an electrode that has little electrical potential loss when lithium is discharged, via a simple manufacturing process. Thus, the electrode active material can be suitably used as an electrode active material for nonaqueous electrolyte secondary batteries. The electrode active material is particularly suitable as the active material of electrodes of lithium or lithium-ion secondary batteries.

Electrode

The electrode of the present invention is characterized by comprising the electrode active material described above. The form and method for fabricating the electrode are not particularly limited. Examples of the method for fabricating the electrode of the present invention include methods in which the electrode is fabricated by mixing the silicon-containing carbon-based composite material with a binder, and methods in which the electrode is fabricated by mixing the silicon-containing carbon-based composite material with a binder and a solvent, contact binding or coating the obtained paste on a current collector and, thereafter, drying the electrode. Moreover, a thickness of the paste coated on the current collector is, for example, about 30 to 500 μm and preferably about 50 to 300 μm. Means for drying after coating are not particularly limited, but heating under vacuum drying is preferable. A thickness of the electrode material on the current collector after drying is about 10 to 300 μm and preferably about 20 to 200 μm. When the silicon-containing carbon-based composite material is fibrous, the electrode can be fabricated by orienting the material in a single axial direction and forming the material into a fabric or similar structure, or bundling or weaving metal, conducting polymer, or similar conductive fibers. Terminals may be incorporated as necessary when forming the electrode.

The current collector is not particularly limited, and specific examples thereof include metal meshes and foils made from copper, nickel, alloys thereof, and the like.

Specific examples of the binder include fluorine-based (e.g. polyvinylidene fluoride and polytetrafluoroethylene) resins and styrene-butadiene resins. An amount in which the binder is used is not particularly limited, but a lower limit thereof is in a range from 5 to 30 parts by mass (weight) and preferably in a range from 5 to 20 parts by mass (weight), per 100 parts by mass (weight) of the silicon-containing carbon-based composite material. When the amount of the binder used is outside these ranges, for example, bonding strength of the silicon-containing carbon-based composite material on the surface of the current collector will be insufficient; and an insulating layer, which is a cause of increased internal resistance of the electrode, may form. A method for preparing the paste is not particularly limited, and examples thereof include methods in which a mixed liquid (or dispersion) comprising the binder and an organic solvent is mixed with the silicon-containing carbon-based composite material.

A solvent that can dissolve or disperse the binder is generally used as the solvent, and specific examples thereof include N-methylpyrrolidone, N,N-dimethylformamide, and similar organic solvents. An amount in which the solvent is used is not particularly limited provided that when mixed with the binder, the mixture thereof has a paste-like form, but generally the amount is in a range from 0.01 to 500 parts by mass (weight), preferably in a range from 0.01 to 400 parts by mass (weight), and more preferably in a range from 0.01 to 300 parts by mass (weight), per 100 parts by mass (weight) of the silicon-containing carbon-based composite material.

Additives may be compounded in the electrode of the present invention as desired. For example, a conductivity promoter may be added to the electrode during manufacturing. An amount in which the conductivity promoter is used is not particularly limited, but is in a range from 2 to 60 parts by mass (weight), preferably in a range from 5 to 40 parts by mass (weight), and more preferably in a range from 5 to 20 parts by mass (weight) per 100 parts by mass (weight) of the silicon-containing carbon-based composite material. When the amount is within this range, conductivity will be excellent and declines in the charging and discharging capacity of the electrode can be suppressed.

Examples of the conductivity promoter include carbon blacks (e.g. ketjen black, acetylene black), carbon fibers, carbon nanotubes, and the like. A single conductivity promoter may be used or a combination of two or more types of conductivity promoters can be used. The conductivity promoter can, for example, be mixed with the paste comprising the silicon-containing carbon-based composite material, the binder, and the solvent.

Graphite or a similar electrode active material may be compounded in the electrode of the present invention as another optional additive.

Electricity Storage Device

The electricity storage device of the present invention is characterized by comprising the electrode described above. Examples of the electricity storage device include lithium primary batteries, lithium secondary batteries, lithium-ion secondary batteries, capacitors, hybrid capacitors (redox capacitors), organic radical batteries, and dual carbon batteries, of which lithium or lithium-ion secondary batteries are preferable. The lithium-ion secondary battery may be manufactured according to a generally known method using battery components including a negative electrode comprising the electrode described above, a positive electrode capable of storing and discharging lithium, an electrolyte solution, a separator, a current collector, a gasket, a sealing plate, a case, and the like. The lithium secondary battery may be manufactured according to a generally known method using battery components including a positive electrode constituted by the electrode described above, a negative electrode constituted by metallic lithium, an electrolyte solution, a separator, a current collector, a gasket, a sealing plate, a case, and the like.

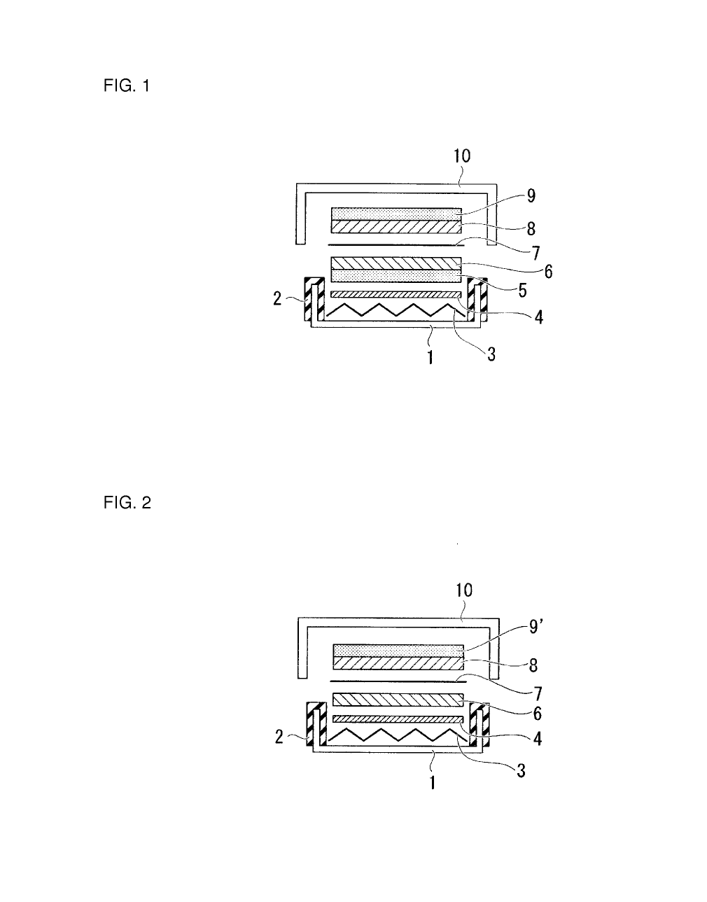

Preferable forms (lithium or lithium-ion secondary batteries) of the battery of the present invention are illustrated in detail in FIGS. 1 and 2.

FIG. 1 is a schematic breakdown cross sectional view of a lithium-ion secondary battery (button battery) that is an example of the battery of the present invention.

The lithium-ion secondary battery illustrated in FIG. 1 comprises a cylindrical case 1 having a bottom and an open top, a cylindrical gasket 2 that is open on both ends and has an inner circumference that is substantially the same as the outer circumference of the case 1, a washer 3, an SUS plate 4, a current collector 5, a negative electrode 6 having the silicon-containing carbon-based composite material of the present invention as an electrode active material thereof, a separator 7, a positive electrode 8, a current collector 9, and a sealing plate 10.

The washer 3, having a substantially ring-like shape and a size that is slightly smaller than the inner circumference of the case 1 is housed in the case 1 of the lithium-ion secondary battery illustrated in FIG. 1. The SUS plate 4, having a substantially disc-like shape and a size that is slightly smaller than the inner circumference of the case 1, is stacked on the washer 3. The current collector 5 and the negative electrode 6, both having substantially disc-like shapes and sizes that are slightly smaller than the inner circumference of the case 1, are provided on the SUS plate 4. The separator 7, which is a single-layer disc-like member and has a size substantially the same as the inner circumference of the case 1, is stacked on the negative electrode 6. The separator 7 is impregnated with an electrolyte solution. Note that the separator 7 may be constituted by two or more disc-like members. The positive electrode 8, having a size that is substantially the same as that of the negative electrode 6, and the current collector 9 having a size that is substantially the same as that of the current collector 5 are provided on the separator 7. The current collector 5 is constituted by a mesh, foil, or the like made from copper, nickel, or similar metal, and the current collector 9 is constituted by a mesh, foil, or the like made from aluminum or a similar metal. The current collector 5 and the current collector 9 are bonded and integrated with the negative electrode 6 and the positive electrode 8, respectively.

With the lithium-ion secondary battery illustrated in FIG. 1, the gasket 2 is fitted on a wall face of the case 1 and; furthermore, an inner circumferential face of the cylindrical sealing plate 10, having a bottom and an open lower face and a size that is slightly larger than that of the gasket 2, is fitted on an outer circumferential face of the gasket 2. Thereby, the case 1 is insulated from the sealing plate 10 by the gasket 2, and a button battery having the case 1, the gasket 2, the washer 3, the SUS plate 4, the current collector 5, the negative electrode 6, the separator 7, the positive electrode 8, the current collector 9, and the sealing plate 10, with a common axis, is formed.

The positive electrode 8 in the lithium-ion secondary battery illustrated in FIG. 1 is not particularly limited and, for example, can be constituted by positive electrode active materials, conductivity promoters, binders, and the like. Examples of the positive electrode active materials include LiCoO₂, LiNiO₂, LiMn₂O₄, and similar metallic oxides; LiFePO₄, Li₂FeSiO₄, and similar polyanion oxides; spinel LiMn₂O₄; and the like. A single positive electrode active material may be used or a combination of two or more types of positive electrode active materials can be used. Examples of the conductivity promoters and the binders include those described above.

FIG. 2 is a breakdown cross sectional view of a lithium secondary battery (button battery) that is an example of the battery of the present invention, fabricated according to the Practical Examples.

The lithium secondary battery illustrated in FIG. 2 comprises a cylindrical case 1 having a bottom and an open top, a cylindrical gasket 2 that is open on both ends and has an inner circumference that is substantially the same as the outer circumference of the case 1, a washer 3, an SUS plate 4, a negative electrode 6 constituted by metallic lithium, a separator 7, a positive electrode 8 having the silicon-containing carbon-based composite material of the present invention as an electrode active material thereof, a current collector 9′, and a sealing plate 10.

The washer 3, having a substantially ring-like shape and a size that is slightly smaller than the inner circumference of the case 1 is housed in the case 1 of the lithium secondary battery illustrated in FIG. 2. The SUS plate 4, having a substantially disc-like shape and a size that is slightly smaller than the inner circumference of the case 1, is stacked on the washer 3. The negative electrode 6, having a substantially disc-like shape and a size that is slightly smaller than the inner circumference of the case 1, is provided on the SUS plate 4. The separator 7, which is a single-layer disc-like member and has a size substantially the same as the inner circumference of the case 1, is stacked on the negative electrode 6. The separator 7 is impregnated with an electrolyte solution. Note that the separator 7 may be constituted by two or more disc-like members. The positive electrode 8 and the current collector 9′, having sizes that are substantially the same as that of the negative electrode 6, are provided on the separator 7. The current collector 9′ is constituted by a mesh, foil, or the like made from copper, nickel, or similar metal, and is bonded and integrated with the positive electrode 8.

With the lithium secondary battery illustrated in FIG. 2, the gasket 2 is fitted on a wall face of the case 1; and an inner circumferential face of the cylindrical sealing plate 10, having a bottom and an open lower face and a size that is slightly larger than that of the gasket 2, is fitted on an outer circumferential face of the gasket 2. Thereby, the case 1 is insulated from the sealing plate 10 by the gasket 2, and a button battery having the case 1, the gasket 2, the washer 3, the SUS plate 4, the negative electrode 6, the separator 7, the positive electrode 8, the current collector 9′, and the sealing plate 10, with a common axis, is formed.

The electrolyte solutions included in the lithium or lithium-ion secondary batteries illustrated in FIGS. 1 and 2 are not particularly limited, and commonly known electrolyte solutions can be used. For example, a non-aqueous lithium or lithium-ion secondary battery can be manufactured by using a solution in which an electrolyte is dissolved in an organic solvent as the electrolyte solution. Examples of the electrolyte include LiPF₆, LiClO₄, LiBF₄, LiClF₄, LiAsF₆, LiSbF₆, LiAlO₄, LiAlCl₄, LiCl, LiI, and similar lithium salts. Examples of the organic solvent include carbonates (e.g. propylene carbonate, ethylene carbonate, diethyl carbonate), lactones (e.g. γ-butyrolactone), chained ethers (e.g. 1,2-dimethoxyethane, dimethylether, diethylether), cyclic ethers (e.g. tetrahydrofuran, 2-methyltetrahydrofuran, dioxolane, 4-methyldioxolane), sulfolanes (e.g. sulfolane), sulfoxides (e.g. dimethyl sulfoxide), nitriles (e.g. acetonitrile, propionitrile, benzonitrile), amides (e.g. N,N-dimethylformamide, N,N-dimethylacetamide), polyoxyalkylene glycols (e.g. diethyleneglycol), and similar aprotic solvents. A single organic solvent may be used or a mixed solvent comprising two or more types of organic solvents can be used. A concentration of the electrolyte per one liter of the electrolyte solution is, for example, about from 0.3 to 5 moles, preferably about from 0.5 to 3 moles, and more preferably about from 0.8 to 1.5 moles.

The separators 4 in the lithium or lithium-ion secondary batteries illustrated in FIGS. 1 and 2 are not particularly limited, and a commonly known separator can be used. Examples thereof include porous polypropylene nonwovens, porous polyethylene nonwovens, and other polyolefin-based porous films.

The electricity storage device of the present invention is not limited to the examples illustrated in FIGS. 1 and 2 and, for example, can be applied to various forms such as stacked, packed, button, gum, battery pack, and rectangular batteries. Utilizing the characteristics of light-weight, high capacity, and high energy density, the electricity storage device of the present invention, particularly, the lithium or lithium-ion secondary battery, is suitable for use as a power supply for video cameras, computers, word processors, portable stereos, cellular phones, and other mobile, small electronic devices; a power supply for hybrid vehicles and electric vehicles; and a power supply for electricity storage.

### INDUSTRIAL APPLICABILITY

The electrode active material of the present invention has high reversible capacity and stable charge and discharge cycle characteristics, and has high initial charge and discharge efficiency. Therefore, the electrode active material of the present invention is suitable for an electrode of an electricity storage device, particularly of a lithium or lithium-ion secondary battery. Additionally, the electrode active material of the present invention uses inexpensive raw materials, and can be manufactured via a simple manufacturing process. Moreover, the electrode of the present invention can impart high reversible capacity, stable charge and discharge cycle characteristics, and high initial charge and discharge efficiency to a battery. As a result, the electricity storage device of the present invention can have high reversible capacity, stable charge and discharge cycle characteristics, and high initial charge and discharge efficiency.

### EXAMPLES

Hereinafter, the present invention will be described in detail based on Practical Examples and Comparative Examples. However, the present invention is not limited to these Practical Examples. In the Practical Examples and Comparative Examples, elemental analyses and evaluations of the battery characteristics were carried out as described below.

Elemental Analyses

C, H, and N analyses: Calculated from the sum of amounts of each element detected via an oxygen transfer combustion method, a TCD detection method and a high frequency combustion method, and an infra-red absorption detection method.

Device: NCH-21 or NCH-22F (manufactured by Sumika Chemical Analysis Service, Ltd.)
Device: CS-LS600 (manufactured by LECO Japan Corporation)
Device: Kamomatto 12ADG (manufactured by Westhoff GmbH)
O analysis: High-temperature carbon reaction, NDIR detection method
Device: EMGA-2800 (manufactured by Horiba, Ltd.)
Si analysis: ICP detection was performed after breaking down the sample by carbonizing, alkali melting, and acidic dissolving.
Device: iCAP6500 DuoView (manufactured by Thermo Fisher Scientific K.K.)

Battery Characteristics

Lithiation and delithiation capacities of the silicon-containing carbon material of the present invention were measured as described below.

The measuring of the lithiation and delithiation capacities was performed using a HJ1010m SMSA (manufactured by Hokuto Denko Corporation). Here, the theoretical capacity with respect to the weight of the silicon-containing carbon material was 700 mAh, and current value was adjusted to be 70 mA with respect to the weight of the silicon-containing carbon material. The capacity when the battery voltage reached 0.005 V, and the current value was 1/10 was considered to be the lithiation capacity. The capacity until battery voltage reached 1.5 V was considered to be the delithiation capacity. However, in Practical Examples 11 to 13 and Comparative Examples 4 to 7, the lithiation and delithiation capacities were measured by adjusting the current value to be from 0.12 to 0.13 mA per electrode unit area (cm²). The capacity until battery voltage reached 0 V was considered to be the lithiation capacity, and the capacity until battery voltage reached 1.5 V was considered to be the delithiation capacity. When switching between the lithiation and delithiation, circuits were left in an open state for 30 minutes. Other than changing the constant current to 140 mA with respect to the weight of the silicon-containing carbon material for the second and subsequent cycles, conditions of the cycle characteristics were the same. Efficiency of the first cycle was calculated using the following formula.

Initial irreversible capacity loss (%)=(Delithiation capacity of first cycle/Lithiation capacity of first cycle)×100

The delithiation capacity of the second cycle was considered to be the reversible capacity, and the capacity maintenance ratio after the cycle test was expressed as a ratio of the delithiation capacity after the cycle test to said delithiation capacity.

### Practical Example 1

### Preparation of the Silicon-Containing Cured Product

A crosslinkable composition was prepared by mixing 15.49 g of DVB570 (manufactured by Nippon Steel Chemical Co., Ltd.; Main components: divinylbenzene 57.0 mass (weight) % and vinyl ethylbenzene 38.9 mass (weight) %; proportion of divinylbenzene included in the main components: 60 mass (weight) %); 10.61 g of a methylhydrogenpolysiloxane capped at both molecular terminals with trimethylsiloxy groups (viscosity: 20 mPa·s; silicon-bonded hydrogen atoms content: 1.58 mass (weight) %; included in an amount such that about one mole of the silicon-bonded hydrogen atoms in the copolymer is included per one mole of vinyl groups in the DVB570); and a 1,3-divinyltetramethyl disiloxane platinum complex platinum catalyst (included in an amount such that 10 ppm of metallic platinum is included). Thereafter, a cured product was prepared by curing the obtained composition in nitrogen at a temperature of 120° C.

Preparation of the Silicon-Containing Carbon Material

4 g of the cured product described above was placed in a carbon crucible and said crucible was set in an Oxynon furnace (oxidation-free continuous furnace). Thereafter, the cured product was baked for one hour at a temperature of 1,000° C. while supplying 4% hydrogen-containing high purity nitrogen at a flow rate of 10 L/minute. The obtained baked product was pulverized using a ball mill and classified using a 300 mesh. Thereby, a silicon-containing carbon material was obtained. The chemical composition of the silicon-containing carbon material is shown in Table 1.

Fabrication of the Electrode

85 mass (weight) % of the silicon-containing carbon material obtained above and 5 mass (weight) % of carbon black were mixed for 15 minutes. Thereafter, a 5 mass (weight) % polyvinylidene fluoride-containing N-methyl-2-pyrrolidone solution was added in an amount such that the polyvinylidene fluoride was 10 mass (weight) % of the solid content. Furthermore, an appropriate amount of N-methyl-2-pyrrolidone was added and the mixture was stirred for 15 minutes. Thereby, a slurry-like mixture was obtained. Then, the slurry-like mixture was coated on a copper foil roll by means of a doctor blade method. The electrode obtained as a result was stored for 12 hours or longer in a vacuum at a temperature of 85° C. and, thereby, an electrode having a thickness of about 50 μm was fabricated.

Fabrication and Evaluation of the Secondary Battery

The electrode, metallic lithium was used for a counterelectrode; a mixed solvent comprising ethylene carbonate and diethyl carbonate at a volume ratio of 1:1, in which lithium hexafluorophosphate was dissolved at a ratio of 1 mol/L, was used as the electrolyte solution; and a polypropylene nonwoven was used as the separator to fabricate a coin-type lithium secondary battery. Constant current charging and discharging measurements were performed at a constant current of 0.4 mA. The characteristics of the battery of Practical Example 1 are shown in Table 2.

### Practical Example 2

### Preparation of the Silicon-Containing Cured Product

A crosslinkable composition was prepared by mixing 775 g of DVB570 (manufactured by Nippon Steel Chemical Co., Ltd.; Main components: divinylbenzene 57.0 mass (weight) % and vinyl ethylbenzene 38.9 mass (weight) %; proportion of divinylbenzene included in the main components: about 60 mass (weight) %); 531 g of a methylhydrogenpolysiloxane capped at both molecular terminals with trimethylsiloxy groups (viscosity: 20 mPa·s; silicon-bonded hydrogen atoms content: 1.58 mass (weight) %; included in an amount such that about one mole of the silicon-bonded hydrogen atoms in the copolymer is included per one mole of vinyl groups in the DVB570); and a 1,3-divinyltetramethyl disiloxane platinum complex platinum catalyst (included in an amount such that 10 ppm of metallic platinum is included). Thereafter, a cured product was prepared by curing the obtained composition in air at a temperature of 120° C.

Preparation of the Silicon-Containing Carbon Material

969 g of the cured product were placed in an SSA-S grade alumina crucible and the crucible was set in a degreasing oven. Thereafter, a state of reduced pressure was maintained in the degreasing oven for 10 minutes, and then high purity nitrogen (99.99%) was used to return the oven to a normal pressure. This operation was repeated a total of one time. Thereafter, the temperature was raised at a rate of 2° C./minute while supplying high purity nitrogen at a flow rate of 2 L/minute, and the cured product was baked for two hours at a temperature of 600° C. 591 g of the obtained baked product was placed in an SSA-S grade alumina crucible and the crucible was set in a muffle furnace. Thereafter, a state of reduced pressure was maintained in the muffle furnace for 60 minutes, and then high purity nitrogen (99.99%) was used to return the oven to a normal pressure. This operation was repeated a total of one time. Thereafter, the temperature was raised at a rate of 5° C./minute while supplying high purity argon at a flow rate of 100 mL/minute, and the cured product was baked for one hour at a temperature of 1,000° C. Thereby, a baked product was obtained. The obtained baked product was pulverized using an air jet pulverizer, and then classified using a high precision air classifier. Thereby, a silicon-containing carbon material was obtained. The chemical composition of the silicon-containing carbon material is shown in Table 1.

Fabrication of the Electrode

An electrode having a thickness of about 40 μm was fabricated the same as that of Practical Example 1.

Fabrication and Evaluation of the Secondary Battery

Other than setting the constant current for the initial charging and discharging measurements to 0.4 mA, measurements were performed the same as in Practical Example 1. The characteristics of the battery of Practical Example 2 are shown in Table 2.

### Practical Example 3

### Preparation of the Silicon-Containing Cured Product

Other than curing the composition in nitrogen at a temperature of 120° C., preparation was performed the same as in Practical Example 2.

Preparation of the Silicon-Containing Carbon Material

1,200 g of the cured product were placed in an SSA-S grade alumina crucible and the crucible was set in a degreasing oven. Thereafter, a state of reduced pressure was maintained in the degreasing oven for 10 minutes, and then high purity nitrogen (99.99%) was used to return the oven to a normal pressure. This operation was repeated a total of one time. Thereafter, the temperature was raised at a rate of 2° C./minute while supplying high purity nitrogen at a flow rate of 2 L/minute, and the cured product was baked for two hours at a temperature of 600° C. The obtained baked product was pulverized using an air jet pulverizer, and then classified using a high precision air classifier. 800 g of the baked product obtained after the pulverizing and classifying were placed in a carbon crucible, and the crucible was set in an Oxynon furnace. Thereafter, the baked product was baked for one hour at a temperature of 1,000° C. while supplying 4 vol. % hydrogen-containing high purity nitrogen at a flow rate of 10 L/minute and, thereby, a silicon-containing carbon material was obtained. The chemical composition of the obtained silicon-containing carbon material is shown in Table 1.

Fabrication of the Electrode

An electrode having a thickness of about 40 μm was fabricated the same as that of Practical Example 1.

Fabrication and Evaluation of the Secondary Battery

Other than setting the constant current for the charging and discharging measurements to 0.3 mA, measurements were performed the same as in Practical Example 1. The characteristics of the battery of Practical Example 3 are shown in Table 2.

### Practical Example 4

### Preparation of the Silicon-Containing Cured Product

A crosslinkable composition was prepared by mixing 3.0 g of a diphenyl bis(dimethylvinylsiloxy)silane (vinyl group content: 14.06 mass (weight) %); 0.98 g of a methylhydrogenpolysiloxane capped at both molecular terminals with trimethylsiloxy groups (viscosity: 20 mPa·s; silicon-bonded hydrogen atoms content: 1.58 mass (weight) %; included in an amount such that one mole of the silicon-bonded hydrogen atoms in the copolymer is included per one mole of vinyl groups in the diphenyl bis(dimethylvinylsiloxy)silane); and a 1,3-divinyltetramethyl disiloxane platinum complex platinum catalyst (included in an amount such that 10 ppm of metallic platinum is included). Thereafter, a cured product was prepared by curing the obtained composition in nitrogen at a temperature of 150° C.

Preparation of the Silicon-Containing Carbon Material

3.7 g of the cured product were placed in an SSA-S grade alumina crucible and the crucible was set in a degreasing oven. Thereafter, a state of reduced pressure was maintained in the degreasing oven for 10 minutes, and then high purity nitrogen (99.99%) was used to return the oven to a normal pressure. This operation was repeated a total of one time. Thereafter, the temperature was raised at a rate of 2° C./minute while supplying high purity nitrogen at a flow rate of 2 L/minute, and the cured product was baked for two hours at a temperature of 600° C. The obtained baked product was pulverized using a ball mill and classified using a 300 mesh. 2.2 g of the baked product obtained after the pulverizing and classifying was placed in an SSA-S grade alumina crucible and the crucible was set in a muffle furnace. Thereafter, a state of reduced pressure was maintained in the muffle furnace for 60 minutes, and then high purity nitrogen (99.99%) was used to return the oven to a normal pressure. This operation was repeated a total of one time. Thereafter, the temperature was raised at a rate of 5° C./minute while supplying high purity argon at a flow rate of 100 mL/minute, and the cured product was baked for one hour at a temperature of 1,000° C. Thereby, a silicon-containing carbon material was obtained. The chemical composition of the silicon-containing carbon material is shown in Table 1.

Fabrication of the Electrode

An electrode having a thickness of about 40 μm was fabricated the same as that of Practical Example 1.

Fabrication and Evaluation of the Secondary Battery

Other than setting the constant current for the charging and discharging measurements to 0.3 mA, measurements were performed the same as in Practical Example 1. The characteristics of the battery of Practical Example 4 are shown in Table 2.

### Practical Example 5

### Preparation of the Silicon-Containing Cured Product

A crosslinkable composition was prepared by mixing 6.38 g of a diphenyl bis(dimethylhydrogensiloxy)silane (silicon-bonded hydrogen atom content: 0.66 mass (weight) %); 3.63 g of a methyl vinyl cyclic (viscosity: 4 mPa·s; silicon-bonded vinyl group content: 31.4 mass (weight) %; included in an amount such that about one mole of the silicon-bonded vinyl groups in the cyclic is included per one mole of silicon-bonded hydrogen atoms in the diphenyl bis(dimethylhydrogensiloxy)silane); and a 1,3-divinyltetramethyl disiloxane platinum complex platinum catalyst (included in an amount such that 10 ppm of metallic platinum is included). Thereafter, a cured product was prepared by curing the obtained composition in nitrogen at a temperature of 150° C.

Preparation of the Silicon-Containing Carbon Material

9.04 g of the cured product were placed in an SSA-S grade alumina crucible and the crucible was set in a degreasing oven. Thereafter, a state of reduced pressure was maintained in the degreasing oven for 10 minutes, and then high purity nitrogen (99.99%) was used to return the oven to a normal pressure. This operation was repeated a total of one time. Thereafter, the temperature was raised at a rate of 2° C./minute while supplying high purity nitrogen at a flow rate of 2 L/minute, and the cured product was baked for two hours at a temperature of 600° C. The obtained baked product was pulverized using a ball mill and classified using a 300 mesh. 1.78 g of the baked product obtained after the pulverizing and classifying was placed in an SSA-S grade alumina crucible and the crucible was set in a muffle furnace. Thereafter, a state of reduced pressure was maintained in the muffle furnace for 60 minutes, and then high purity nitrogen (99.99%) was used to return the oven to a normal pressure. This operation was repeated a total of one time. Thereafter, the temperature was raised at a rate of 5° C./minute while supplying high purity argon at a flow rate of 100 mL/minute, and the cured product was baked for one hour at a temperature of 1,000° C. Thereby, a silicon-containing carbon material was obtained. The chemical composition of the silicon-containing carbon material is shown in Table 1.

Fabrication of the Electrode

An electrode having a thickness of about 50 μm was fabricated the same as that of Practical Example 1.

Fabrication and Evaluation of the Secondary Battery

Other than setting the constant current for the charging and discharging measurements to 0.4 mA, measurements were performed the same as in Practical Example 1. The characteristics of the battery of Practical Example 5 are shown in Table 2.

### Practical Example 6

### Preparation of the Silicon-Containing Cured Product

A crosslinkable composition was prepared by mixing 7.83 g of a diphenylsiloxane capped at both molecular terminals with dimethylhydrogensiloxy groups (manufactured by Dow Corning Toray Co., Ltd.; viscosity: 118 mPa·s; silicon-bonded hydrogen atom content: 0.32 mass (weight) %); 2.18 g of a methyl vinyl cyclic (viscosity: 4 mPa·s; silicon-bonded vinyl group content: 31.4 mass (weight) %; included in an amount such that about one mole of the silicon-bonded vinyl groups in the cyclic is included per one mole of silicon-bonded hydrogen atoms in the diphenylsiloxane capped at both molecular terminals with dimethylhydrogensiloxy groups); and a 1,3-divinyltetramethyl disiloxane platinum complex platinum catalyst (included in an amount such that 10 ppm of metallic platinum is included). Thereafter, a cured product was prepared by curing the obtained composition in nitrogen at a temperature of 150° C.

Preparation of the Silicon-Containing Carbon Material

9.04 g of the cured product were placed in an SSA-S grade alumina crucible and the crucible was set in a degreasing oven. Thereafter, a state of reduced pressure was maintained in the degreasing oven for 10 minutes, and then high purity nitrogen (99.99%) was used to return the oven to a normal pressure. This operation was repeated a total of one time. Thereafter, the temperature was raised at a rate of 2° C./minute while supplying high purity nitrogen at a flow rate of 2 L/minute, and the cured product was baked for two hours at a temperature of 600° C. The obtained baked product was pulverized using a ball mill and classified using a 300 mesh. 2.12 g of the baked product obtained after the pulverizing and classifying was placed in an SSA-S grade alumina crucible and the crucible was set in a muffle furnace. Thereafter, a state of reduced pressure was maintained in the muffle furnace for 60 minutes, and then high purity nitrogen (99.99%) was used to return the oven to a normal pressure. This operation was repeated a total of one time. Thereafter, the temperature was raised at a rate of 5° C./minute while supplying high purity argon at a flow rate of 100 mL/minute, and the cured product was baked for one hour at a temperature of 1,000° C. Thereby, a silicon-containing carbon material was obtained. The chemical composition of the silicon-containing carbon material is shown in Table 1.

Fabrication of the Electrode

An electrode having a thickness of about 40 μm was fabricated the same as that of Practical Example 1.

Fabrication and Evaluation of the Secondary Battery

Other than setting the constant current for the charging and discharging measurements to 0.4 mA, measurements were performed the same as in Practical Example 1. The characteristics of the battery of Practical Example 6 are shown in Table 2.

### Comparative Example 1

### Preparation of the Silicon-Containing Cured Product

A crosslinkable composition was prepared by mixing 15.49 g of DVB570 (manufactured by Nippon Steel Chemical Co., Ltd.; Main components: divinylbenzene 57.0 mass (weight) % and vinyl ethylbenzene 38.9 mass (weight) %; proportion of divinylbenzene included in the main components: about 60 mass (weight) %); 2.65 g of a methylhydrogenpolysiloxane capped at both molecular terminals with trimethylsiloxy groups (viscosity: 20 mPa·s; silicon-bonded hydrogen atoms content: 1.58 mass (weight) %; included in an amount such that about 0.25 mole of the silicon-bonded hydrogen atoms in the copolymer is included per one mole of vinyl groups in the DVB570); and a 1,3-divinyltetramethyl disiloxane platinum complex platinum catalyst (included in an amount such that 10 ppm of metallic platinum is included). Thereafter, a cured product was prepared by curing the obtained composition in nitrogen at a temperature of 120° C.

Preparation of the Silicon-Containing Carbon Material

4 g of the cured product described above was placed in a carbon crucible and said crucible was set in an Oxynon furnace. Thereafter, the cured product was baked for one hour at a temperature of 1,000° C. while supplying 4 vol. % hydrogen-containing high purity nitrogen at a flow rate of 10 llminute. The obtained baked product was pulverized using a ball mill and classified using a 300 mesh. Thereby, a silicon-containing carbon material was obtained. The chemical composition of the silicon-containing carbon material is shown in Table 1.

Fabrication of the Electrode

An electrode having a thickness of about 40 μm was fabricated the same as that of Practical Example 1.

Fabrication and Evaluation of the Secondary Battery

Other than setting the constant current for the charging and discharging measurements to 0.4 mA, measurements were performed the same as in Practical Example 1. The characteristics of the battery of Comparative Example 1 are shown in Table 2.

### Comparative Example 2

### Preparation of the Silicon-Containing Cured Product

A crosslinkable composition was prepared by mixing 10 g of a tetramethyldivinyldisiloxane (manufactured by Dow Corning Toray Co., Ltd.); 6.7 g of a methylhydrogenpolysiloxane capped at both molecular terminals with trimethylsiloxy groups (viscosity: 20 mPa·s; silicon-bonded hydrogen atoms content: 1.58 mass (weight) %; included in an amount such that about one mole of the silicon-bonded hydrogen atoms in the copolymer is included per one mole of vinyl groups in the tetramethyldivinyldisiloxane); and a 1,3-divinyltetramethyl disiloxane platinum complex platinum catalyst (included in an amount such that 10 ppm of metallic platinum is included). Thereafter, a cured product was prepared by curing the obtained composition in nitrogen at a temperature of 120° C.

Preparation of the Silicon-Containing Carbon Material

4.0 g of the cured product were placed in an SSA-S grade alumina crucible and the crucible was set in a degreasing oven. Thereafter, a state of reduced pressure was maintained in the degreasing oven for 10 minutes, and then high purity nitrogen (99.99%) was used to return the oven to a normal pressure. This operation was repeated a total of one time. Thereafter, the temperature was raised at a rate of 2° C./minute while supplying high purity nitrogen at a flow rate of 2 L/minute, and the cured product was baked for two hours at a temperature of 600° C. The obtained baked product was pulverized using a ball mill and classified using a 300 mesh. 2.0 g of the baked product obtained after the pulverizing and classifying were placed in a carbon crucible, and the crucible was set in an Oxynon furnace. Thereafter, the baked product was baked for one hour at a temperature of 1,100° C. while supplying 4 vol. % hydrogen-containing high purity nitrogen at a flow rate of 10 L/minute and, thereby, a silicon-containing carbon material was obtained. The chemical composition of the silicon-containing carbon material is shown in Table 1.

Fabrication of the Electrode

An electrode having a thickness of about 40 μm was fabricated the same as that of Practical Example 1.

Fabrication and Evaluation of the Secondary Battery

Other than setting the constant current for the charging and discharging measurements to 0.4 mA, measurements were performed the same as in Practical Example 1. The characteristics of the battery of Comparative Example 2 are shown in Table 2.

### Practical Example 7

### Preparation of the Silicon-Containing Cured Product

A crosslinkable composition was prepared by mixing 28.45 g of DVB570 (manufactured by Nippon Steel Chemical Co., Ltd.; Main components: divinylbenzene 57.0 mass (weight) % and vinyl ethylbenzene 38.9 mass (weight) %; proportion of divinylbenzene included in the main components: about 60 mass (weight) %); 6.25 g of a methylhydrogenpolysiloxane capped at both molecular terminals with trimethylsiloxy groups (viscosity: 20 mPa s; silicon-bonded hydrogen atoms content: 1.58 mass (weight) %; included in an amount such that about 0.3 mole of the silicon-bonded hydrogen atoms in the copolymer is included per one mole of vinyl groups in the DVB570); and a 1,3-divinyltetramethyl disiloxane platinum complex platinum catalyst (included in an amount such that 10 ppm of metallic platinum is included). Thereafter, a cured product was prepared by curing the obtained composition in nitrogen at a temperature of 150° C.

Preparation of the Silicon-Containing Carbon Material

20.28 g of the cured product were placed in an SSA-S grade alumina crucible and the crucible was set in a degreasing oven. Thereafter, a state of reduced pressure was maintained in the degreasing oven for 10 minutes, and then high purity nitrogen (99.99%) was used to return the oven to a normal pressure. This operation was repeated a total of one time. Thereafter, the temperature was raised at a rate of 2° C./minute while supplying high purity nitrogen at a flow rate of 2 L/minute, and the cured product was baked for two hours at a temperature of 600° C. The obtained baked product was pulverized using a ball mill and classified using a 300 mesh. 2.14 g of the baked product obtained after the pulverizing and classifying were placed in an SSA-S grade alumina crucible and the crucible was set in a muffle furnace. Thereafter, a state of reduced pressure was maintained in the muffle furnace for 60 minutes, and then high purity nitrogen (99.99%) was used to return the oven to a normal pressure. This operation was repeated a total of one time. Thereafter, the temperature was raised at a rate of 5° C./minute while supplying high purity argon at a flow rate of 100 mL/minute, and the cured product was baked for one hour at a temperature of 1,000° C. Thereby, a silicon-containing carbon material was obtained. The chemical composition of the silicon-containing carbon material is shown in Table 1.

Fabrication of the Electrode

An electrode having a thickness of about 50 μm was fabricated the same as that of Practical Example 1.

Fabrication and Evaluation of the Secondary Battery

Other than setting the constant current for the charging and discharging measurements to 0.4 mA, measurements were performed the same as in Practical Example 1. The characteristics of the battery of Practical Example 7 are shown in Table 3.

### Practical Example 8

### Preparation of the Silicon-Containing Cured Product

A crosslinkable composition was prepared by mixing 8.54 g of DVB570 (manufactured by Nippon Steel Chemical Co., Ltd.; Main components: divinylbenzene 57.0 mass (weight) % and vinyl ethylbenzene 38.9 mass (weight) %; proportion of divinylbenzene included in the main components: about 60 mass (weight) %); 12.50 g of a methylhydrogenpolysiloxane capped at both molecular terminals with trimethylsiloxy groups (viscosity: 20 mPa·s; silicon-bonded hydrogen atoms content: 1.58 mass (weight) %; included in an amount such that about 2 moles of the silicon-bonded hydrogen atoms in the copolymer is included per one mole of vinyl groups in the DVB570); and a 1,3-divinyltetramethyl disiloxane platinum complex platinum catalyst (included in an amount such that 10 ppm of metallic platinum is included). Thereafter, a cured product was prepared by curing the obtained composition in nitrogen at a temperature of 150° C.

Preparation of the Silicon-Containing Carbon Material

20.21 g of the cured product were placed in an SSA-S grade alumina crucible and the crucible was set in a degreasing oven. Thereafter, a state of reduced pressure was maintained in the degreasing oven for 10 minutes, and then high purity nitrogen (99.99%) was used to return the oven to a normal pressure. This operation was repeated a total of one time. Thereafter, the temperature was raised at a rate of 2° C./minute while supplying high purity nitrogen at a flow rate of 2 L/minute, and the cured product was baked for two hours at a temperature of 600° C. The obtained baked product was pulverized using a ball mill and classified using a 300 mesh. 1.93 g of the baked product obtained after the pulverizing and classifying were placed in an SSA-S grade alumina crucible and the crucible was set in a muffle furnace. Thereafter, a state of reduced pressure was maintained in the muffle furnace for 60 minutes, and then high purity nitrogen (99.99%) was used to return the oven to a normal pressure. This operation was repeated a total of one time. Thereafter, the temperature was raised at a rate of 5° C./minute while supplying high purity argon at a flow rate of 100 mL/minute, and the cured product was baked for one hour at a temperature of 1,000° C. Thereby, a silicon-containing carbon material was obtained. The chemical composition of the silicon-containing carbon material is shown in Table 1.

Fabrication of the Electrode

An electrode having a thickness of about 45 μm was fabricated the same as that of Practical Example 1.

Fabrication and Evaluation of the Secondary Battery

Other than setting the constant current for the charging and discharging measurements to 0.4 mA, measurements were performed the same as in Practical Example 1. The characteristics of the battery of Practical Example 8 are shown in Table 3.

### Practical Example 9

### Preparation of the Silicon-Containing Cured Product

A crosslinkable composition was prepared by mixing 2026 g of ((CH₃)₃SiO_{1/2})_{1.0}(CH₂═CHSiCH₃O_{2/2})_{2.7}(C₆H₅SiO_{3/2})_{2.5} (hereinafter “MD(Vi)T resin”; viscosity: 773 mPa·s); 1939 g of ((CH₃)₃SiO_{1/2})_{1.0}(HSiCH₃O_{2/2})_{3.4}(C₆H₅SiO_{3/2})_{3.8} (hereinafter “MD(H)T resin”; viscosity: 5446 mPa·s; included in an amount such that about one mole of the silicon-bonded hydrogen atoms in the MD(H)T resin is included per one mole of vinyl groups in the MD(Vi)T resin); and a 1,3-divinyltetramethyl disiloxane platinum complex platinum catalyst (included in an amount such that 5 ppm of metallic platinum is included). Thereafter, the composition was placed in a rotary kiln (manufactured by Takasago Industry Co., Ltd.) and the composition was cured at a temperature of 230° C. in 0.4 vol. % hydrogen-containing high purity nitrogen.

Preparation of the Silicon-Containing Carbon Material

Then, the temperature in the rotary kiln was raised to 600° C., and the cured product was baked for one hour in a 0.4 vol. % hydrogen-containing high purity nitrogen atmosphere while being rotated at 1 rpm. Thereafter, the temperature was raised up to 1000° C. and the cured product was heated for another one hour, and, thereby, 3020 g of baked product was obtained. After pulverizing the obtained baked product to less than 2 mm by a jaw crusher (manufactured by Retsch Co., Ltd.), the baked product was further pulverized by using an air jet pulverizer (Nippon Pneumatic Mfg. Co., Ltd.). Thereby, a silicon-containing carbon material having a median diameter of 5 μm measured by a laser diffraction method was obtained. The chemical composition of the silicon-containing carbon material is shown in Table 1.

Fabrication of the Electrode

An electrode having a thickness of about 40 μm was fabricated the same as that of Practical Example 1.

Fabrication and Evaluation of the Secondary Battery

Other than setting the constant current for the charging and discharging measurements to 0.4 mA, measurements were performed the same as in Practical Example 1. The characteristics of the battery of Practical Example 9 are shown in Table 3.

### Practical Example 10

### Preparation of Carbon Coated Silicon-Containing Carbon Material

600 g of the silicon-containing carbon material prepared in Practical Example 9 was placed in the rotary kiln. Then, the temperature in the rotary kiln was raised to 1000° C. and the silicon-containing carbon material was cured in 1.3 vol. % hydrogen-containing high purity nitrogen while being rotated at 1 rpm. Thereafter, the silicon-containing carbon material was baked for one hour while being rotated at 1 rpm and supplying a mixture of high purity nitrogen and 25% methane at a flow rate of 3 L/minute and, thereby, 545 g of a carbon coated silicon-containing carbon material was obtained. The chemical composition of the carbon coated silicon-containing carbon material is shown in Table 1.

Fabrication of the Electrode

An electrode having a thickness of about 40 μm was fabricated the same as that of Practical Example 1.

Fabrication and Evaluation of the Secondary Battery

Other than setting the constant current for the charging and discharging measurements to 0.4 mA, measurements were performed the same as in Practical Example 1. The characteristics of the battery of Practical Example 10 are shown in Table 3.

### Practical Example 11

### Fabrication of the Electrode

Other than using the silicon-containing carbon material prepared in Practical Example 7 in place of the silicon-containing carbon material prepared in Practical Example 1 and using a polyvinylidene fluoride powder (in an amount such that the polyvinylidene fluoride powder was 10 mass (weight) % of the solid content) in place of 5 mass (weight) % of polyvinylidene fluoride-containing N-methyl-2-pyrrolidone solution, an electrode was fabricated the same as that of Practical Example 1.

Fabrication and Evaluation of the Secondary Battery

A battery was fabricated the same as that of Practical Example 1 and evaluated. The characteristics of the battery of Practical Example 11 are shown in Table 4.

### Practical Example 12

### Fabrication of the Electrode

Other than using the silicon-containing carbon material prepared in Practical Example 8 in place of the silicon-containing carbon material prepared in Practical Example 7, an electrode was fabricated the same as that of Practical Example 11.

Fabrication and Evaluation of the Secondary Battery

A battery was fabricated the same as that of Practical Example 1 and evaluated. The characteristics of the battery of Practical Example 12 are shown in Table 4.

### Practical Example 13

### Fabrication of the Electrode

Other than using the silicon-containing carbon material prepared in Practical Example 10 in place of the silicon-containing carbon material prepared in Practical Example 7, an electrode was fabricated the same as that of Practical Example 11.

Fabrication and Evaluation of the Secondary Battery

A battery was fabricated the same as that of Practical Example 1 and evaluated. The characteristics of the battery of Practical Example 13 are shown in Table 4.

### Comparative Example 3

### Preparation of the Silicon-Containing Cured Product

A crosslinkable composition was prepared by mixing 17.20 g of methyl vinyl cyclics (manufactured by Dow Corning Toray Co., Ltd.; viscosity: 4 mPa·s; silicon-bonded vinyl group content: 31.4 mass (weight) %); 12.50 g of a methylhydrogenpolysiloxane capped at both molecular terminals with trimethylsiloxy groups (viscosity: 20 mPa·s; silicon-bonded hydrogen atoms content: 1.58 mass (weight) %; included in an amount such that about one mole of the silicon-bonded hydrogen atoms in the copolymer is included per one mole of vinyl groups in the tetramethyldivinyldisiloxane); and a 1,3-divinyltetramethyl disiloxane platinum complex platinum catalyst (included in an amount such that 10 ppm of metallic platinum is included). Thereafter, a cured product was prepared by curing the obtained composition in nitrogen at a temperature of 150° C.

Preparation of the Silicon-Containing Carbon Material

28.78 g of the cured product were placed in an SSA-S grade alumina crucible and the crucible was set in a degreasing oven. Thereafter, a state of reduced pressure was maintained in the degreasing oven for 10 minutes, and then high purity nitrogen (99.99%) was used to return the oven to a normal pressure. This operation was repeated a total of one time. Thereafter, the temperature was raised at a rate of 2° C./minute while supplying high purity nitrogen at a flow rate of 2 L/minute, and the cured product was baked for two hours at a temperature of 600° C. The obtained baked product was pulverized using a ball mill and classified using a 300 mesh. 1.59 g of the baked product obtained after the pulverizing and classifying were placed in an SSA-S grade alumina crucible and the crucible was set in a muffle furnace. Thereafter, a state of reduced pressure was maintained in the muffle furnace for 60 minutes, and then high purity nitrogen (99.99%) was used to return the oven to a normal pressure. This operation was repeated a total of one time. Thereafter, the temperature was raised at a rate of 5° C./minute while supplying high purity argon at a flow rate of 100 mL/minute, and the cured product was baked for one hour at a temperature of 1,000° C. Thereby, a silicon-containing carbon material was obtained. The chemical composition of the silicon-containing carbon material is shown in Table 1.

Fabrication of the Electrode

An electrode having a thickness of about 40 μm was fabricated the same as that of Practical Example 1.

Fabrication and Evaluation of the Secondary Battery

Other than setting the constant current for the charging and discharging measurements to 0.4 mA, measurements were performed the same as in Practical Example 1. The characteristics of the battery of Comparative Example 3 are shown in Table 3.

### Comparative Example 4

### Preparation of the Silicon-Containing Carbon Material

A mixture of 249 FLAKE resin (manufactured by Dow Corning Toray Co., Ltd.) and phenolaralkyl resin (XLC-3L; manufactured by Mitsui Chemicals, Inc.) mixed at a weight ratio of 1:1 was prepared. 4.40 g of the cured product were placed in an SSA-S grade alumina crucible and the crucible was set in a degreasing oven. Thereafter, a state of reduced pressure was maintained in the degreasing oven for 10 minutes, and then high purity nitrogen (99.99%) was used to return the oven to a normal pressure. This operation was repeated a total of one time. Thereafter, the temperature was raised at a rate of 2° C./minute while supplying high purity nitrogen at a flow rate of 2 L/minute, and the cured product was baked for two hours at a temperature of 600° C. The obtained baked product was pulverized using a ball mill and classified using a 300 mesh. 1.30 g of the baked product obtained after the pulverizing and classifying was placed in an SSA-S grade alumina crucible and the crucible was set in a muffle furnace. Thereafter, a state of reduced pressure was maintained in the muffle furnace for 60 minutes, and then high purity nitrogen (99.99%) was used to return the oven to a normal pressure. This operation was repeated a total of one time. Thereafter, the temperature was raised at a rate of 5° C./minute while supplying high purity argon at a flow rate of 100 mL/minute, and the cured product was baked for one hour at a temperature of 1,000° C. Thereby, a silicon-containing carbon material was obtained. The chemical composition of the silicon-containing carbon material is shown in Table 1.

Fabrication of the Electrode

Other than using the silicon-containing carbon material described above in place of the silicon-containing carbon material prepared in Practical Example 7, an electrode was fabricated the same as that of Practical Example 11.

Fabrication and Evaluation of the Secondary Battery

A battery was fabricated the same as that of Practical Example 1 and evaluated. The characteristics of the battery of Comparative Example 4 are shown in Table 3.

### Comparative Example 5

### Preparation of the Silicon-Containing Carbon Material

A mixture of 249 FLAKE resin (manufactured by Dow Corning Toray Co., Ltd.) and phenolaralkyl resin (XLC-3L; manufactured by Mitsui Chemicals, Inc.) mixed at a weight ratio of 1:2 was prepared. 20.8 g of the obtained mixture were placed in an SSA-S grade alumina crucible and the crucible was set in a degreasing oven. Thereafter, a state of reduced pressure was maintained in the degreasing oven for 10 minutes, and then high purity nitrogen (99.99%) was used to return the oven to a normal pressure. This operation was repeated a total of one time. Thereafter, the temperature was raised at a rate of 2° C./minute while supplying high purity nitrogen at a flow rate of 2 L/minute, and the cured product was baked for two hours at a temperature of 600° C. The obtained baked product was pulverized using a ball mill and classified using a 300 mesh. 3.30 g of the baked product obtained after the pulverizing and classifying was placed in an SSA-S grade alumina crucible and the crucible was set in a muffle furnace. Thereafter, a state of reduced pressure was maintained in the muffle furnace for 60 minutes, and then high purity nitrogen (99.99%) was used to return the oven to a normal pressure. This operation was repeated a total of one time. Thereafter, the temperature was raised at a rate of 5° C./minute while supplying high purity argon at a flow rate of 100 mL/minute, and the cured product was baked for one hour at a temperature of 1,000° C. Thereby, a silicon-containing carbon material was obtained. The chemical composition of the silicon-containing carbon material is shown in Table 1.

Fabrication of the Electrode

Other than using the silicon-containing carbon material described above in place of the silicon-containing carbon material prepared in Practical Example 7, an electrode was fabricated the same as that of Practical Example 11.

Fabrication and evaluation of the secondary battery

A battery was fabricated the same as that of Practical Example 1 and evaluated. The characteristics of the battery of Comparative Example 5 are shown in Table 3.

### Comparative Example 6

### Preparation of the Silicon-Containing Carbon Material

A mixture of 249 FLAKE resin (manufactured by Dow Corning Toray Co., Ltd.) and phenolaralkyl resin (XLC-3L; manufactured by Mitsui Chemicals, Inc.) mixed at a weight ratio of 4:1 was prepared. 4.3 g of the obtained mixture were placed in an SSA-S grade alumina crucible and the crucible was set in a degreasing oven. Thereafter, a state of reduced pressure was maintained in the degreasing oven for 10 minutes, and then high purity nitrogen (99.99%) was used to return the oven to a normal pressure. This operation was repeated a total of one time. Thereafter, the temperature was raised at a rate of 2° C./minute while supplying high purity nitrogen at a flow rate of 2 L/minute, and the cured product was baked for two hours at a temperature of 600° C. The obtained baked product was pulverized using a ball mill and classified using a 300 mesh. 1.40 g of the baked product obtained after the pulverizing and classifying was placed in an SSA-S grade alumina crucible and the crucible was set in a muffle furnace. Thereafter, a state of reduced pressure was maintained in the muffle furnace for 60 minutes, and then high purity nitrogen (99.99%) was used to return the oven to a normal pressure. This operation was repeated a total of one time. Thereafter, the temperature was raised at a rate of 5° C./minute while supplying high purity argon at a flow rate of 100 mL/minute, and the cured product was baked for one hour at a temperature of 1,000° C. Thereby, a silicon-containing carbon material was obtained. The chemical composition of the silicon-containing carbon material is shown in Table 1.

Fabrication of the Electrode

Other than using the silicon-containing carbon material described above in place of the silicon-containing carbon material prepared in Practical Example 7, an electrode was fabricated the same as that of Practical Example 11.

Fabrication and Evaluation of the Secondary Battery

A battery was fabricated the same as that of Practical Example 1 and evaluated. The characteristics of the battery of Comparative Example 6 are shown in Table 3.

### Comparative Example 7

### Preparation of the Silicon-Containing Carbon Material

A mixture of 249 FLAKE resin (manufactured by Dow Corning Toray Co., Ltd.) and phenolaralkyl resin (XLC-3L; manufactured by Mitsui Chemicals, Inc.) mixed at a weight ratio of 95:5 was prepared. 4.2 g of the obtained mixture were placed in an SSA-S grade alumina crucible and the crucible was set in a degreasing oven. Thereafter, a state of reduced pressure was maintained in the degreasing oven for 10 minutes, and then high purity nitrogen (99.99%) was used to return the oven to a normal pressure. This operation was repeated a total of one time. Thereafter, the temperature was raised at a rate of 2° C./minute while supplying high purity nitrogen at a flow rate of 2 L/minute, and the cured product was baked for two hours at a temperature of 600° C. The obtained baked product was pulverized using a ball mill and classified using a 300 mesh. 1.40 g of the baked product obtained after the pulverizing and classifying was placed in an SSA-S grade alumina crucible and the crucible was set in a muffle furnace. Thereafter, a state of reduced pressure was maintained in the muffle furnace for 60 minutes, and then high purity nitrogen (99.99%) was used to return the oven to a normal pressure. This operation was repeated a total of one time. Thereafter, the temperature was raised at a rate of 5° C./minute while supplying high purity argon at a flow rate of 100 mL/minute, and the cured product was baked for one hour at a temperature of 1,000° C. Thereby, a silicon-containing carbon material was obtained. The chemical composition of the silicon-containing carbon material is shown in Table 1.

Fabrication of the Electrode

Other than using the silicon-containing carbon material described above in place of the silicon-containing carbon material prepared in Practical Example 7, an electrode was fabricated the same as that of Practical Example 11.

Fabrication and Evaluation of the Secondary Battery

A battery was fabricated the same as that of Practical Example 1 and evaluated. The characteristics of the battery of Comparative Example 7 are shown in Table 3.

TABLE 1

Chemical
composition formula

| | Si | O (x) | C (y) | H (z) |
|---|---|---|---|---|
| Practical Example 1 | 1.0 | 1.1 | 3.5 | 0.6 |
| Practical Example 2 | 1.0 | 1.2 | 3.7 | 0.8 |
| Practical Example 3 | 1.0 | 1.1 | 5.3 | 0.8 |
| Practical Example 4 | 1.0 | 0.9 | 2.6 | 0.4 |
| Practical Example 5 | 1.0 | 0.9 | 2.8 | 0.4 |
| Practical Example 6 | 1.0 | 1.0 | 4.2 | 0.6 |
| Practical Example 7 | 1.0 | 1.1 | 4.9 | 0.5 |
| Practical Example 8 | 1.0 | 0.9 | 2.7 | 0.3 |
| Practical Example 9 | 1.0 | 1.1 | 2.8 | 0.4 |
| Practical Example 10 | 1.0 | 1.1 | 3.0 | 0.3 |
| Comparative Example 1 | 1.0 | 1.7 | 7.9 | 1.4 |
| Comparative Example 2 | 1.0 | 0.8 | 1.3 | 0.3 |
| Comparative Example 3 | 1.0 | 0.9 | 1.3 | 0.2 |
| Comparative Example 4 | 1.0 | 2.3 | 5.8 | 1.7 |
| Comparative Example 5 | 1.0 | 2.2 | 7.3 | 1.9 |
| Comparative Example 6 | 1.0 | 2.0 | 3.5 | 1.5 |
| Comparative Example 7 | 1.0 | 1.6 | 2.7 | 1.0 |

TABLE 2

| | Example | | | | | | | |
|---|---|---|---|---|---|---|---|---|
| Physical | Practical | Practical | Practical | Practical | Practical | Practical | Comparative | Comparative |
| property | Example 1 | Example 2 | Example 3 | Example 4 | Example 5 | Example 6 | Example 1 | Example 2 |
| Reversible | 700 | 738 | 696 | 855 | 837 | 726 | 520 | 884 |
| capacity | | | | | | | | |
| (mAh/g) | | | | | | | | |
| Initial coulomb | 63 | 64 | 68 | 68 | 69 | 68 | 57 | 65 |
| efficiency | | | | | | | | |
| (%) | | | | | | | | |
| Capacity | 87 | 95 | 73 | 98 | 99 | 98 | 82 | <50 |
| maintenance | | | | | | | | |
| ratio after 10 | | | | | | | | |
| cycles | | | | | | | | |
| (%) | | | | | | | | |

TABLE 3

| | Example | | | | |
|---|---|---|---|---|---|
| | Practical | Practical | Practical | Practical | Comparative |
| Physical property | Example 7 | Example 8 | Example 9 | Example 10 | Example 3 |
| Reversible capacity | 700 | 827 | 726 | 784 | 734 |
| (mAh/g) | | | | | |
| Initial coulomb efficiency | 65 | 67 | 63 | 67 | 52 |
| (%) | | | | | |
| Capacity maintenance | 95 | 95 | 79 | 95 | 71 |
| ratio after 10 cycles | | | | | |
| (%) | | | | | |

TABLE 4

| | Example | | | | | | |
|---|---|---|---|---|---|---|---|
| Physical | Practical | Practical | Practical | Comparative | Comparative | Comparative | Comparative |
| property | Example 11 | Example 12 | Example 13 | Example 4 | Example 5 | Example 6 | Example 7 |
| Reversible | 598 | 689 | 670 | 471 | 463 | 527 | 584 |
| capacity | | | | | | | |
| (mAh/g) | | | | | | | |
| Initial coulomb | 63 | 64 | 65 | 50 | 52 | 47 | 49 |
| efficiency | | | | | | | |
| (%) | | | | | | | |

### REFERENCE NUMERALS

1: Case
2: Gasket
3: Washer
4: SUS plate
5: Current collector
6: Negative electrode
7: Separator
8: Positive electrode
9, 9′: Current collector
10: Sealing plate

1. A silicon-containing carbon-based composite material represented by the following compositional formula:
SiOₓC_{y}H_{z}
wherein, x is from 0.8 to 1.5, y is from 1.4 to 7.5, and z is from 0.1 to 0.9.

2. The composite material according to claim 1, obtained by:
obtaining a cured product by crosslinking
(A) a crosslinkable group-containing organic compound, and
(B) a silicon-containing compound capable of crosslinking the crosslinkable group-containing organic compound; and
heat treating the obtained cured product.

3. The composite material according to claim 2, wherein the heat treating is carried out in an inert gas or in a vacuum at a temperature from 300 to 1,500° C.

4. The composite material according to claim 2, wherein the crosslinkable group is selected from the group consisting of aliphatic unsaturated groups, epoxy groups, acryl groups, methacryl groups, amino groups, hydroxyl groups, mercapto groups, and halogenated alkyl groups.

5. The composite material according to claim 2, wherein component (A) has an aromatic group.

6. The composite material according to claim 5, wherein component (A) is an organic compound represented by the following general formula:
(R¹)ₓR²
wherein, R¹ is a crosslinkable group; x is an integer greater than or equal to 1; and R² is an aromatic group with x valency.

7. The composite material according to claim 2, wherein component (A) includes silicon atoms.

8. The composite material according to claim 7, wherein component (A) is a siloxane, a silane, a silazane, a carbosilane, or a mixture thereof.

9. The composite material according to claim 8, wherein the siloxane is represented by the following average unit formula:
(R³₃SiO_{1/2})ₐ(R³₂SiO_{2/2})_{b}(R³SiO_{3/2})_{c}(SiO_{4/2})_{d}
wherein, R³ each independently represents a crosslinkable group, a monovalent substituted or unsubstituted saturated aliphatic hydrocarbon group or aromatic hydrocarbon group having from 1 to 20 carbons, an alkoxy group, a hydrogen atom, or a halogen atom; a, b, c, and d are numbers that are greater than or equal to 0 and less than or equal to 1, and that satisfy a+b+c+d=1, however, a, b, and c cannot be 0 at the same time; and at least one R³ in a molecule is a crosslinkable group.

10. The composite material according to claim 2, wherein component (B) is a siloxane, a silane, a silazane, a carbosilane, or a mixture thereof.

11. The composite material according to claim 10, wherein the siloxane is represented by the following average unit formula:
(R⁷₃SiO_{1/2})ₐ(R⁷₂SiO_{2/2})_{b}(R⁷SiO_{3/2})_{c}(SiO_{4/2})_{d}
wherein, R⁷ each independently represents a monovalent hydrocarbon group, a hydrogen atom, a halogen atom, an epoxy group-containing organic group, an acryl group- or methacryl group-containing organic group, an amino group-containing organic group, a mercapto group-containing organic group, an alkoxy group, or a hydroxy group; a, b, c, and d are numbers that are greater than or equal to 0 and less than or equal to 1, and that satisfy a+b+c+d=1; however, a, b, and c cannot be 0 at the same time.

12. The composite material according to claim 2, wherein the crosslinking is carried out via an addition reaction, a condensation reaction, a ring-opening reaction, or a radical reaction.

13. The composite material according to claim 2, wherein the cured product is obtained by a hydrosilylation reaction of component (A) having aliphatic unsaturated groups and component (B) having silicon-bonded hydrogen atoms.

14. The composite material according to claim 2, wherein the cured product is obtained by a hydrosilylation reaction of component (A) having silicon-bonded hydrogen atoms and component (B) having aliphatic unsaturated groups.

15. The composite material according to claim 2, wherein the cured product is obtained by a radical reaction of component (A) having aliphatic unsaturated groups and component (B) having aliphatic unsaturated groups, acryl groups, methacryl groups, or silicon-bonded hydrogen atoms.

16. The composite material according to claim 2, wherein the cured product is obtained by a radical reaction of component (A) having aliphatic unsaturated groups, acryl groups, methacryl groups, or silicon-bonded hydrogen atoms and component (B) having aliphatic unsaturated groups.

17. The composite material according to claim 1, that is amorphous.

18. The composite material according to claim 1, that is a particulate having an average diameter from 5 nm to 50 μm.

19. An electrode active material comprising the composite material of claim 1.

20. The electrode active material according to claim 19, comprising particles having an average diameter from 1 to 50 μm.

21. An electrode comprising the electrode active material of claim 19.

22. An electricity storage device comprising the electrode of claim 21.

23. The electricity storage device according to claim 22, which is a lithium or lithium-ion secondary battery.
